(19) United States
(12) Patent Application Publication
(10) Pub. No.: US 2004/0201683 A1
(43) Pub. Date: Oct. 14, 2004

(54) Image data dispensing system

(75) Inventors: Kimitaka Murashita, Kawasaki (JP); Shoji Suzuki, Kawasaki (JP); Masayoshi Shimizu, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 09/973,837

(22) Filed: Oct. 11, 2001

(30) Foreign Application Priority Data
Mar. 30, 2001 (JP) 2001-098523

(51) Int. Cl. H04N 5/225

(52) U.S. Cl. 348/207.1

(57) ABSTRACT

A system is provided which would allow users, even though they have no digital camera, nor its peripheral device, nor personal computer, to be provide with digital image data and enjoy its features. The system includes: an image obtaining apparatus, adapted to be lent to a user, for obtaining image data by operation of the user; image manipulating means for manipulating the image data, which has been obtained by the image obtaining apparatus, by a predetermined manipulation process; and image data dispensing means for dispensing the resulting image data, which is the image data as the result of the predetermined manipulation process by the image manipulation means, to the customer for a consideration. The present system is employed in recreation facilities (amusement parks, theme parks, etc.), tourist attractions, and athletic races, so as to provide picture-taking/image-dispensing services.

### BACKGROUND OF THE INVENTION

1. Field of the Invention

The present invention relates to a system for realizing a new type of image data dispensing service.

The invention particularly relates to an image data dispensing system suitable for use in recreation facilities (amusement parks, theme park, and the like), tourist attractions, athletic races, and others, so as to provide customers with photo-taking and image-dispensing services.

2. Description of the Related Art

Digital image producing devices, such as digital still cameras for producing static images and digital movie cameras for producing moving images (both hereinafter collectively called digital cameras), have been becoming popular in these days. A CCD (Charge Coupled Device) equipped in a digital camera converts input optical signals into digital data, which is then converted/compressed into an image format such as JPEG (Joint Photographic Experts Group). The thus created JPEG image is stored in an internal memory medium (memory cards such as CompactFlash™ and SmartMedia™) of the digital camera, via which memory medium the image data would be transferred to other digital devices.

In general, image data taken by a digital camera would be used as follows:

(1) Picture Postcard;

The image data of, say, a family photo is added to a seasonal greeting card, thereby visually telling the sender's recent condition. Such picture postcards have recently been authored both commercially—DPE (Development, Printing, Enlargement) shops of today provide a picture postcard creating service—and independently. In the latter case, a personal computer, a color printer, a dedicated software tool as well as a digital camera would be normally required.

(2) Duplication and Delivery of Image Data;

Image data is delivered to third parties. The image data is delivered in the form of being stored in a portable medium such as a floppy disc, or in the form of being attached to e-mail as a MIME (Multipurpose Internet Mail Extensions). Because it is digital data, the image data can be easily duplicated, at that never being degraded in quality. In order to carry out the above image data delivery, such equipment is required as a portable medium, a drive for the medium, a personal computer which is capable of connecting with the medium, and an Internet connecting device {modem, DSU (Digital Service Unit) or the like} as well as a digital camera.

Digital cameras, compared with conventional film-type cameras, has the following features:

(a1) their image data can be manipulated (“manipulate” means, in the description of the present invention, “add”, “alter”, “edit”, “move”, and so on);

(a2) the image data can be easily deleted;

(a3) a great amount of image data can be obtained using a large capacity memory; and

(a4) their picture image is digital data which is free from image quality deterioration.

On the other hand, there have long been the following problems with digital cameras.

[Problem 1] Additional Equipment is Required for Image Data Manipulation:

Because of its being digital data, the image data obtained by a digital camera can be subject to image data manipulation (character overwriting, color conversion, and image quality correction). Various pieces of equipment (a personal computer and dedicated software, for example) other than a digital camera are essential to carry out image data manipulation. Such devices are normally expensive, thus imposing increasing costs on users. In addition, though the operation of a digital camera is similar to that of the conventional one, the operation of a personal computer is completely different. Accordingly, users who have never used any personal computer, or who are not so familiar with personal computers, would often meet significant difficulties in carrying out such image data manipulation by themselves.

[Problem 2] A Memory, Which is the Counterpart of a Film in a Conventional Camera, is Expensive;

After obtaining image data, a digital camera normally stores the image data in its internal memory. At the purchasing of a digital camera, such a memory is often provided as optionally available equipment, or a small capacity memory of about 10 MB is otherwise attached as original equipment. For example, in case of a two million-pixel digital still camera, the file size of a single picture image is supposed to be approximately 400 KB (a compression rate of 1/15). With a 10 MB-memory originally equipped, if any, merely 25 picture images could be stored therein. As compared with a single conventional camera film that often costs several hundreds of yen (several dollars), a single digital camera memory costs as much as several thousands of yen (several tens of dollars) through several tens of thousands of yen (several hundreds of dollars). An expensive large capacity memory is resultantly necessitated for obtaining a great amount of image data, thereby imposing the increased cost on the user.

[Problem 3] Additional Equipment is Required for Storing Image Data:

A digital camera memory is so expensive that the data stored therein is required to be saved into another storage device. As such storage devices, there are a hard disc, CD-R, MO, DVD-RAM, and so on. Whichever is used, other equipment, such as a storage device, a personal computer, and dedicated software, than a digital camera is essential, thereby causing a similar problem to that confronted at the above-described data manipulation (see problem 1).

### [Problem 4] The Property Value of a Digital Camera Lowers Quickly:

Performance improvements of digital cameras have been remarkable, and various new models have been put into the market one after another. Despite of their high prices, digital cameras thus tend to be outdated for a short period, and thereby their property values are also lowered rapidly.

As described above, even though digital cameras are superior in some points to conventional cameras, it is necessary for users to purchase additional equipment such as dedicated software, and moreover, to acquire skills for operating the equipment.

In view of these problems, there has been longed a bland-new service, in which users are allowed to enjoy the advantages (a1) through (a4) of digital cameras (digital image data) even with no digital camera of their own, and also in which above problem 1 through problem 4 are resolved.

So far the conventional service of taking pictures of customers (or guests; hereinafter called customers) has been provided. For example, in recreation facilities such as amusement parks and theme parks, cameras that are installed in the facilities take pictures of customers, and the developed/printed pictures are sold to the customers. In the service, conventional film cameras or digital cameras are used to take the pictures. However, in order to realize this service, it is required to install not only a camera but also a printing device (developers or printers) at every position where picture-taking is to be carried out, thereby causing the increased cost of preparing the printing devices and also increased running costs (for print sheets, for example). As a result, the pictures had to be provided to customers at high prices. Accordingly, there has been longed a new system, in which pictures (images) are sold/provided to customers with no longer using any printing device or print sheet.

### SUMMARY OF THE INVENTION

With the foregoing problems in view, it is an object of the present invention to provide an image data dispensing system for realizing a brand-new image data dispensing service which would allow users, even without a digital camera of their own, or without its peripheral devices nor personal computers, to enjoy digital image data provided.

In order to accomplish the above object, according to the present invention, there is provided an image data dispensing system comprising: an image obtaining apparatus, adapted to be lent to a customer, for obtaining image data by operation of the customer; image manipulating means for manipulating the image data, which has been obtained by the image obtaining apparatus, by a predetermined manipulation process; and image data dispensing means for dispensing the resulting image data, which is the image data as the result of the predetermined manipulation process by the image manipulation means, to the customer for a consideration.

As one preferred feature of the present invention, the image data dispensing means includes image writing means for writing the resulting image data, which is the image data as the result of the predetermined manipulation process by the image manipulating means, into a portable medium, and the portable medium, into which the resulting image data is written by the image writing means, is purchased by the customer, so that the resulting image data written therein is dispensed to the customer.

As another preferred feature, the image data dispensing means includes: an image server for storing the resulting image data, which is the image data as the result of the predetermined manipulation process by the image manipulating means; and a communication network communicably interconnecting the image server and a customer terminal, so that the resulting image data stored in the image server is dispensed to the customer terminal via the communication network.

As still another preferred feature, the image manipulating means stores added information in a predetermined address of the image data, and an image data dispensing system may further comprise an image viewer for reading out the added data, which is stored by the image manipulating means, and showing the added data on its screen.

The image data dispensing system of the present invention guarantees the following advantageous results.

(1) An image data dispensing system of the present invention accomplishes a brand-new service, in which an image obtaining apparatus is lent to a customer, and image data obtained by the image obtaining apparatus is subjected to predetermined data-manipulation (to add, alter, edit, or move the data), and the resulting image data is dispensed to the customer for a consideration. Hereby, customers even having no image obtaining apparatus of their own, can obtain image data using the ones that are being lent. Further, even with no dedicated image-processing software tool, nor peripheral device, nor information processor device, nor image-processing skill, the customers are capable of obtaining the image data upon which predetermined data manipulation has been performed. More precisely, assuming a digital camera, for example, is used as an image obtaining apparatus, it is possible for a customer to obtain digital image data having undergone predetermined data manipulation, even if the customer does not have a digital camera, nor its peripheral device, nor personal computer, and to enjoy the merits of digital image data. On the other hand, from such service provider's point of view, it is possible not only to earn a rental of the image obtaining apparatus (digital camera), but also to charge for the use of such an image data dispensing service itself or for the image data dispensed to a customer, depending upon the amount of data actually provided.

(2) An image data dispensing system of the present invention accomplishes another brand-new service. In the service, an image data storing apparatus is lent to a customer so as to temporarily store the image data obtained by an image obtaining apparatus therein. The image data stored in the image data storing apparatus is subjected to predetermined data manipulation and then provided to the customer for a consideration. Hereby, it is not only possible to attain the similar effects or profits to those referred to in item (1), but also possible for the customer to obtain a great amount of image data upon which predetermined data manipulation has been performed, without necessity for purchasing any expensive image storing memory for use in the image obtaining apparatus, nor any storage device externally equipped thereto. Meanwhile, from such service provider's point of view, it is possible to earn a rental of the image data storing apparatus.

(3) If, in the system of item (2), one or more image obtaining apparatus are installed in a fixed fashion at predetermined positions, it is only necessary for a customer to carry an image data storing apparatus, thus freed from carrying an image obtaining apparatus. Image data obtained by the above fixedly installed image obtaining apparatus is accumulated in the image data storing apparatus. Provided that such an image data dispensing system is employed in recreation facilities or tourist attractions, and also that a digital camera serves as an image obtaining apparatus, it is possible for a service provider to provide customers with digital image data upon which predetermined manipulation has been performed, with no use of any printing apparatus nor photographic paper sheets, thereby eliminating the cost for the printing apparatus and running costs such as that for the paper sheets, resultantly minimizing the amount charged to the customers. From the customers' viewpoints, since the image is provided in the form of digital data, it is easy to secondarily use the provided image data.

(4) An image data dispensing system of the present invention accomplishes still another brand-new service. In the service, a transmitter is lent to a customer, and in response to a signal received from the transmitter, one or more image obtaining apparatus (fixedly installed) obtain image data. The obtained image data is subjected to predetermined data manipulation and then dispensed to the customer for a consideration. Since it is only required for a customer to carry a transmitter, thus freed from carrying an image obtaining apparatus or an image data storing apparatus, for obtaining desired image data upon which predetermined data manipulation has been performed, the similar effects and profits to those referred to in item (3) can be attained. At that time, the image data obtained by the image obtaining apparatus is transmitted, together with customer identification (ID) information, to an image storing apparatus via a communication network, and then dispensed to the customer corresponding to the ID information. Provided that such an image data providing system is employed in recreation facilities or tourist attractions, and also that a digital camera serves as an image obtaining apparatus, it is no longer required to prepare output terminals, dedicated to the downloading of the image data, one for each digital camera, thereby reducing the cost for the implementation of the system. Additionally, it is possible for customers, without making any particular operations, to receive the digital image data taken by digital cameras, at some predetermined wickets when they leave the facilities.

(5) An image data dispensing system of the present invention accomplishes a further brand-new service. In the service, image data that includes ID information of a customer in the form of an image, is obtained, and the ID information extracted therefrom is used to specify one object customer, to whom a technique for accessing the image data is to be notified. The image data is then dispensed to the customer for a consideration. As a good example, in athletic races such as marathon, ekiden, triathlon, and road racing, every entrant puts on a number card (bib) on which a bib number (ID information), unique to each entrant, is printed. Accordingly, provided that the image data providing system is employed to take photos of the entrants of various races, and also that a digital camera is used as an image obtaining apparatus, it can be prospected that a picture image thus taken contains a bib number that identifies who the subject of the picture image is (this is also referred to as “to specify the customer”). Such a bib number is extracted from the picture image for use in dispensing the image data to the corresponding customer, thereby attaining the similar effects and profits to those referred to in item (1).

(6) By selling portable media (CD-R discs, MO discs, or others) that store the image data upon which predetermined data manipulation has been performed, a service provider can provide digital image data, for a consideration, even to customers who have no digital camera nor personal computer. From the customers' standpoints, it is possible to keep a great amount of image data saved in such portable media, without purchasing any expensive image storing memory or external storage device.

(7) Since the image data subjected to predetermined data manipulation can be stored in an image server and dispensed to customers through a communication network, with no use of any portable medium, it is possible for a service provider to lower the charge for an image data dispensing service.

(8) In case where the image data is stored and managed in an image server, a customer is allowed to access the image data stored in the image server during a certain period, depending upon the amount of charge the customer has paid. Hereby it is possible for a service provider to earn a charge (server managing charge) for storing and managing the image data in the image server.

(9) In case where the image data is stored and managed in an image server, a customer's accessing to (downloading) the image data stored in a image server is permitted upon the payment of a predetermined charge made by the customer. Hereby it is possible for a service provider to collect a charge for the image data at its being downloaded.

(10) In case where the image data is dispensed from an image server, a reference image (an image of lower quality than the original one: thumbnail, for example) of the image data stored in the image server is dispensed to a customer without charge, and thereby it is possible for the customer to decide whether or not to download the object image data, referring to the reference image.

(11) In case where the image data is stored and managed in an image server, it is possible to automatically delete the image data whose charge has not yet been paid even after elapse of a predetermined period. Unnecessary image data is thus automatically removed from the image server, thereby enabling an effective use of storage areas in the image server.

(12) Since, as predetermine data manipulation, added information is stored in a predetermined address of the image data, it is possible for a customer, when referring to the image data itself, to refer also to the added information concurrently, so that various information can be obtained. At that time, the customer can use an image viewer to show both the image data and the added information thereon.

(13) Since such added information might be an advertisement (company data, or else) relevant to where the image data has been obtained, it is possible to dispense some advertisement information not only to an object customer, but also to third parties (anyone who is involved in a network of the customer's personal contacts: the customer's acquaintances, for example). Such advertisement information is expected to significantly contribute to increase in repeat customers and new customers. At that time, partly since a display available period, during which the added information is adapted to be shown, can be designated, and partly since the image viewer is adapted to show the added information only during the display available period, it is possible to show advertisement information only for a limited period (for which the advertisement is valid) as the service provider wishes. Further, if it is found, at the time of storing the latest image data, that any other image data has been previously stored where (a portable medium or an image server) the object image data is now to be stored, it is possible to replace the old advertisement stored in the previous image data with a new one, thereby updating the advertisement information, so that the latest advertisement information can always be dispensed to customers.

(14) Since the added information might be when, or the date and time, the object image data was obtained, or the customer's personal data relevant to the object image data, it is possible for the customer, even when a great amount image data is stored, to refer to the added information so as to know where, when, and with whom each picture image has been taken. Hence, the added information can be effectively used in organizing the image data.

(15) In case where the image data is obtained by one or more image obtaining apparatus fixedly installed, the added information stored in a predetermined address of the image data might be the information of the predetermined position where the image obtaining apparatus is previously installed (where the picture image has been obtained). Since the positional information can be stored automatically, it is no longer necessary to check or to input such positional data separately.

(16) So-called image-processing (sharpening, color managing, and so on) is carried out as predetermined data manipulation, so that customers can obtain high-quality image data upon which predetermined image-processing has been performed, even with no dedicated software tool nor operation skill.

(17) In case where the image data is obtained by one or more image obtaining apparatus fixedly installed, an available light color temperature is obtained in view of when (date and time) and where the image data was obtained (where the image obtaining apparatus is installed), and the white balance of the image data is corrected depending on the thus obtained available light color temperature, so that customers can be provided with high-quality image data upon which the white balance correction has been performed, even with no dedicated software tool nor operation skill.

Other objects and further features of the present invention will be apparent from the following detailed description when read in conjunction with the accompanying drawings.

### BRIEF DESCRIPTION OF THE DRAWINGS

FIG. 1 is a block diagram showing an image data dispensing system of a first embodiment of the present invention;

FIG. 2 is a flowchart illustrating an operation of the image data dispensing system of FIG. 1;

FIG. 3 is a block diagram showing an image data dispensing system of a second embodiment of the present invention;

FIG. 4 and FIG. 5 are flowcharts each illustrating an operation of the image data dispensing system of FIG. 3;

FIG. 6 is a block diagram showing an image data dispensing system of a third embodiment of the present invention;

FIG. 7 is a flowchart illustrating an operation of the image data dispensing system of FIG. 6;

FIG. 8 is a block diagram showing an image data dispensing system of a fourth embodiment of the present invention;

FIG. 9 is a block diagram showing a substantial part of the image data dispensing system of the fourth embodiment of the present invention;

FIG. 10 and FIG. 11 are flowcharts each illustrating an operation of the image data dispensing system of the fourth embodiment of the present invention;

FIG. 12 is a block diagram showing an image data dispensing system of a fifth embodiment of the present invention;

FIG. 13 is a block diagram showing an entire structure of an image data dispensing system of the fifth embodiment with that of FIG. 12 inclusive;

FIG. 14 is a flowchart illustrating an operation of the image data dispensing system of the fifth embodiment of the present invention;

FIG. 15 is a block diagram showing an image data dispensing system of a sixth embodiment of the present invention;

FIG. 16 is a flowchart illustrating an operation of the image data dispensing system of FIG. 15;

FIG. 17 is a block diagram showing an image data dispensing system of a seventh embodiment of the present invention;

FIG. 18 is a flowchart illustrating an operation of the image data dispensing system of FIG. 17;

FIG. 19 is a diagram illustrating a first mode of image data manipulation technique according to the above embodiments of the present invention;

FIG. 20 is a diagram showing a first example of an image data dispensing system according to the above embodiments, to which system the first mode of image data manipulation technique is applied;

FIG. 21 is a diagram showing an image viewer employed in an image data dispensing system according to the above embodiments, to which system the first mode of image data manipulation technique is applied;

FIG. 22 is a diagram showing a second example of an image data dispensing system according to the above embodiments, to which system the first mode of image data manipulation technique is applied;

FIG. 23 is a diagram showing a third example of an image data dispensing system according to the above embodiments, to which system the first mode of image data manipulation technique is applied;

FIG. 24 is a diagram showing a first example of an image data dispensing system according to the above embodiments, to which system a second mode of image data manipulation technique is applied; and

FIG. 25 is a diagram showing a second example of an image data dispensing system according to the above embodiments, to which system the second mode of image data manipulation technique is applied.

### DESCRIPTION OF THE PREFERRED EMBODIMENT(S)

Various preferred embodiments of the present invention will now be described in detail below with reference to relevant accompanying drawings.

### [1] First Embodiment

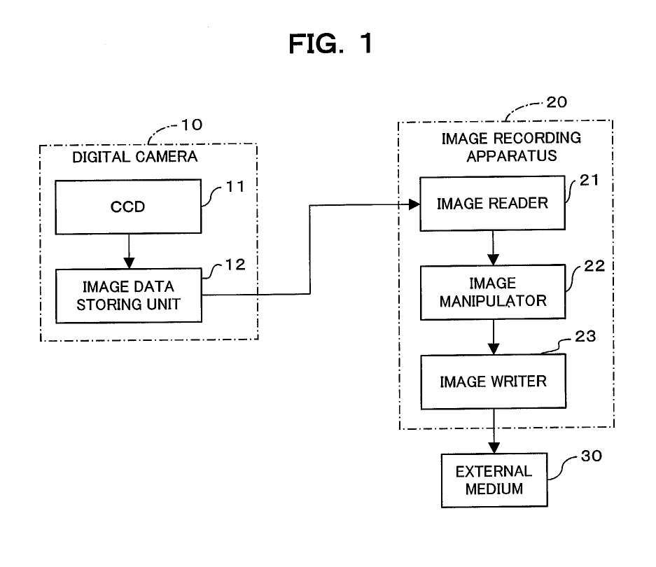

FIG. 1 shows a schematic of an image data dispensing system of a first embodiment of the present invention. The image data dispensing system of the first embodiment, as shown in FIG. 1, includes digital camera 10 and image recording apparatus 20.

Digital camera 10, which includes charge coupled device (CCD) 11 and image data storing unit 12, is lent to a customer, and serves as an image obtaining apparatus for obtaining image data by operation of the customer. The image data obtained by CCD 11 is digitized by image data storing unit 12 and temporarily stored therein. Image data storing unit 12 has, say, a JPEG coding circuit and an image buffer.

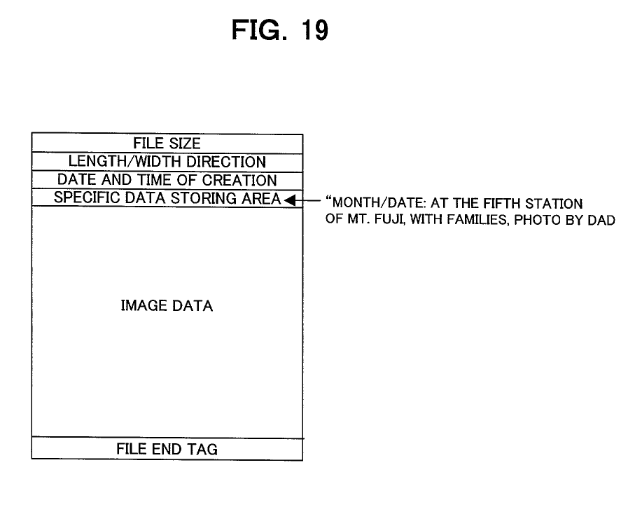

Image recording apparatus 20 includes image reader 21, image manipulator 22, and image writer 23. In use, an information processor such as a personal computer would serve as the image recording apparatus 20. Image reader 21, which is in use a terminal (say, a USB (Universal Serial Bus)) that is connectable with digital camera 10, receives the image data taken by the digital camera 10. Image manipulator 22 performs predetermined data manipulation (data-altering, -editing, -moving, -adding and so on) upon the image data that has been received by image reader 21; concrete examples of the data manipulation will be described in detail later, with reference to FIG. 19 through FIG. 25. Image writer 23 writes the resulting image data, which is the image data as the result of the predetermined manipulation by the image manipulator 22, in external medium (portable medium) 30.

Here, the external medium 30 is a portable external storage medium, such as a MO disc, a CD-R disc, and a hard disc unit (a small-sized magnetic disc device). Image writer 23 is a disc drive complied with the type of the external medium 30, say, a MO drive and a CD-R drive.

Image recording apparatus 20 serves as an image data dispensing means for dispensing the resulting image data, which is the image data as the result of the predetermined manipulation process, to a customer for a consideration. In an image data dispensing system of the first embodiment, the image data is dispensed to a customer by selling the customer external medium 30 containing the image data having been recorded therein.

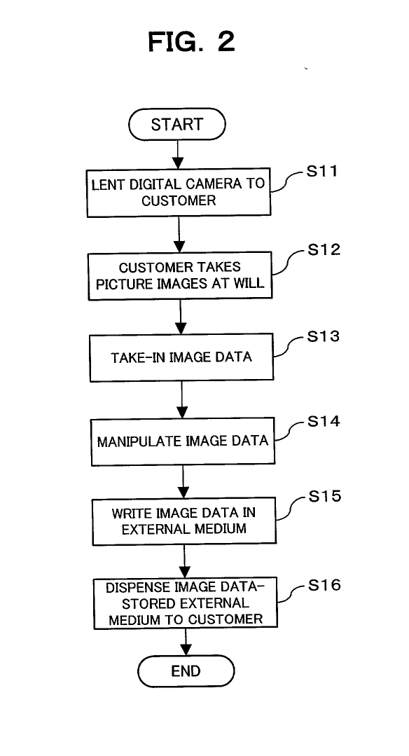

A description will now be made hereinbelow of an operation of an image data dispensing system of the first embodiment, with reference to the flowchart (step S11 through step S16) of FIG. 2.

A service provider first lends/provides digital camera 10 to a customer (step S11). The customer takes picture images at will with the digital camera (step S12).

When the customer returns the digital camera 10, the service provider connects the digital camera 10 with image recording apparatus 20, and image reader 21 then fetches the image data stored in image data storing unit 12 of the digital camera 10 (step S13) After that, image manipulator 22 performs predetermined data manipulation upon the image data (step S14), and image writer 23 writes the image data in external medium 30 (step S15). The external medium 30 is sold/dispensed to the customer (step S16) for a predetermined charge (consideration).

In these days, some DPE (Development, Printing, Enlargement) shops, which has been providing an ordinary photo-developing service of developing conventional types of camera films, have also entered upon a new service of printing-out the image data that has been taken with digital cameras. This service has already been started also at some convenience stores. Under such circumstances of today, after purchasing external medium 30 containing the image data recorded therein, the customer would be able to bring it to a DPE stand or a convenience store to make the image data printed out, thereby obtaining the digital picture images.

In this manner, according to the first embodiment, it is possible to realize a new image data dispensing service in which a digital camera 10 is lent to a customer, and image data taken with the digital camera 10 is subjected to predetermined data manipulation, and the resulting image data is dispensed to the customer for a consideration.

Hereby, customers even having no digital cameras 10 of their own, are capable of obtaining image data with the ones that are being lent. Further, even with no dedicated image-processing software tool, nor peripheral device of digital camera 10, nor personal computer, nor operation skill for image-processing, the customers are still capable of obtaining the image data upon which predetermined data manipulation has been performed, and enjoying the merits of digital image data. Moreover, it is possible for the customers to keep a great amount of image data in the form of being stored in external medium 30, without purchasing any expensive image storing memory or external storage device.

On the other hand, it is possible for a service provider not only to earn a rental of the digital camera 10, but also to charge customers for the use of such an image data dispensing service itself (namely, by selling external media 30). At that time, the amount charged might depend upon the amount of image data written in the external media 30.

### [2] Second Embodiment

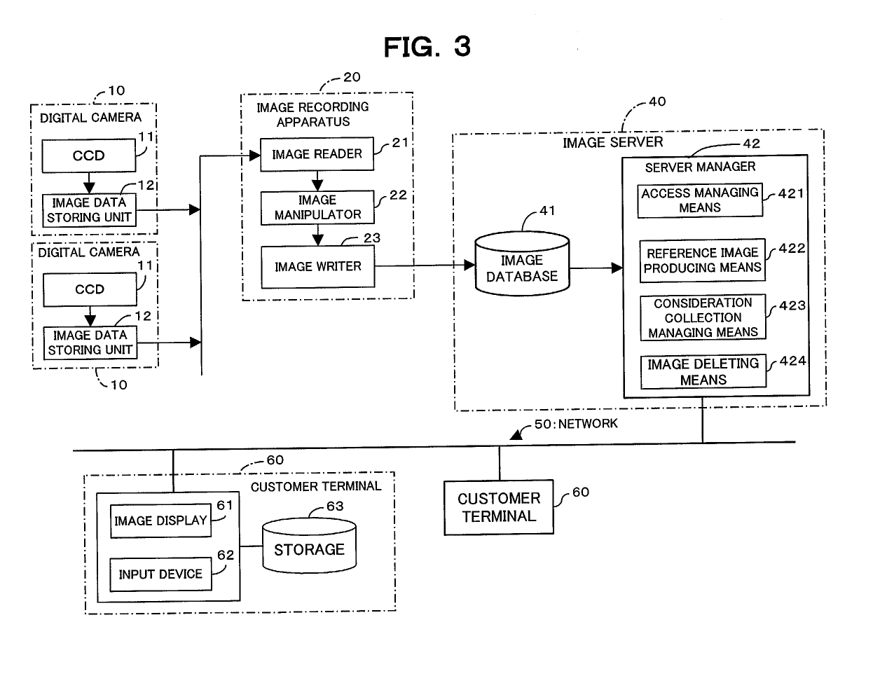

FIG. 3 is a schematic of an image data dispensing system of a second embodiment of the present invention. As shown in FIG. 3, the image data dispensing system of the second embodiment, like that of the first embodiment, includes digital camera 10 and image recording apparatus 20, and it additionally includes image server 40 connected with communication network 50. In this instance, like reference numbers to those which have already been described designate similar parts or elements, so their detailed description is omitted here.

In comparison with the first embodiment, where the image data is stored in an external medium 30, which is then to be purchased by a customer, the image data is stored, in the second embodiment, in image server 40, and a customer receives the image data via communication network 50 such as the Internet. In other words, image server 40 and communication network 50 make up an image data dispensing means.

Image server 40 includes image database 41 and server manager 42. Image database 41 stores the image data, which has been subjected to the data manipulation performed by image manipulator 22 and then written therein by image writer 23 of image recording apparatus 20. Server manager 42, which manages image database 41, is communicably connected with customer terminal 60 via communication network 50. In response to accessing from customer terminal 60, server manager 42 dispenses the requested image data to the customer.

Further, server manager 42 serves also as access managing means 421, reference image producing means 422, consideration collection managing means 423, and image deleting means 424. In practical use, a CPU executes predetermined applications, thereby realizing the above functions.

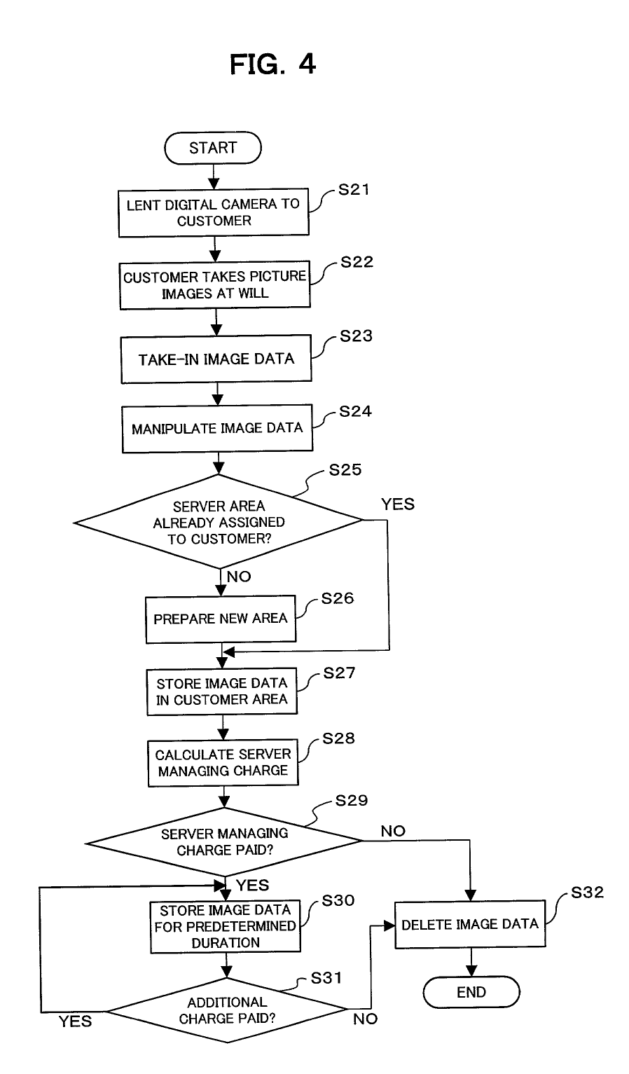

Here, access managing means 421 executes either one of the following functions: managing access from customer terminal 60 to the image data stored in image server 40, such that the access is permitted only for a limited period depending upon an amount of charge the customer has paid for the consideration (described later with reference to FIG. 4) (function 1); or such that the access is permitted upon the payment of a predetermined charge made by the customer (function 2).

Reference image producing means 422 produces a reference image (say, thumbnail image) from the image data stored in image server 40. Reference image producing means 422 is activated in case where the image stored in image server 40 is provided through WWW (World Wide Web) under the condition where access managing means 421 executes above-mentioned function 2. The reference image produced by reference image producing means 422 is dispensed to a customer (customer terminal 60) at no charge via communication network 50.

As such a reference image, an image of lower quality than the original one, as monochrome images, resolution-lowered images, and highly compressed images of degraded quality, is produced. The quality of such a reference image is poor but enough for a customer to recognize what the original image is like. Because of its low resolution and poor image quality, the reference image would not be so useful to the customer.

Consideration collection managing means 423 manages the collection of considerations (charges) for image data. On the basis of the date and time of storing the image data and also the current date and time, consideration collection managing means 423 evaluates whether or not a charge-uncollected period, or the time period during which the charge for the image data has been unpaid, exceeds a predetermined duration.

Image deleting means 424 deletes the corresponding image data from image server 40 (image database 41) if the result of the evaluation by consideration collection managing means 423 is positive.

Here, though image server 40 is directly connected with image recording apparatus 20 in FIG. 3, image recording apparatus 20 might alternatively be connected with communication network 50, via which the image data is transmitted and stored in image database 41, thereby making it possible to install image server 40 at a remote location from image recording apparatus 20.

Customer terminal 60, which is realized in use by an information processor such as a personal computer, is used for accessing image server 40. Customer terminal 60 includes image display (CRT display) 61, input device (keyboard, mouse, or others) 62, and storage device (hard disc unit) 63. A customer accesses image server 40 from customer terminal 60 via communication network 50 such as the Internet, and makes the picture images the customer has taken by himself/herself or the reference images which have been produced from the picture images shown on image display 61. Referring to those images shown on the display 61, the customer downloads preferred images from the image server 40 onto storage device 63.

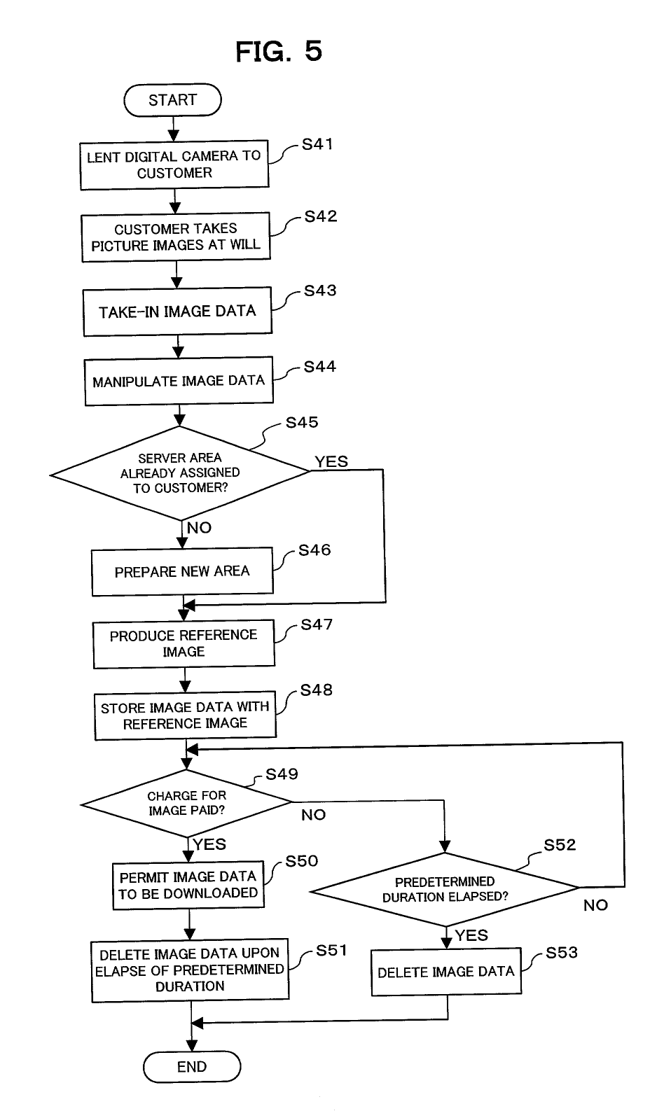

Next, a description will now be made hereinbelow of an operation of the image data dispensing system of the second embodiment, with reference to FIG. 4 and FIG. 5.

Firstly, the description will be made in case where access managing means 421 executes above-mentioned function 1, referring to the flowchart (steps S21 through S32) of FIG. 4.

A service provider lends/provides digital camera 10 to a customer (step S21). The user takes picture images at will with the digital camera 10 (step S22). When the customer returns the digital camera 10, the service provider connects the digital camera 10 with image recording apparatus 20, and image reader 21 of the digital camera 10 then fetches the image data stored in image data storing unit 12 of the digital camera 10 (step S23). After that, image manipulator 22 performs predetermined data manipulation upon the image data (step S24).

After that, either one of image writer 23 or server manager 42 evaluates whether or not the object customer, whose image data is now being stored, reserves his/her own storage area in image database 41 (step S25). If the evaluation yields a negative result (NO route of step S25), image writer 23 creates a new area for the customer in image database 41 (step S26), and then writes and stores the image data in the newly created storage area (step S27). Otherwise if the evaluation yields a positive result (YES route of step S25), image writer 23 writes and stores the image data in the existing preserved area for the customer (step S27).

Subsequently, the service provider calculates a server managing charge (step S28) based on the number of files, file sizes, file storing durations, and so on. If the customer agrees to pay the server managing charge and then the payment is made (YES route of step S29), the service provider keeps the image data in image database 41 for a predetermined (according to the amount of the payment) period (step S30). Otherwise if the customer refuses to pay the charge, image deleting means 424 deletes the image data currently stored in image database 41 (step S32).

Here, with elapse of the above predetermined period, if the customer pays an additional charge to extend the image data-preserving period (YES route of step S31), the image data will be continued to be kept in image database 41. Otherwise if the payment is not made (NO route of step S31), image deleting means 424 deletes the image data from image database 41 (step S32).

The evaluations made in step S29 and S31, might be executed alternatively by consideration collection managing means 423. Under the condition where the service provider receives the charge directly from the customer, information as to the completion or incompletion of the payment might be input by the service provider from its terminal.

Secondly, a description will be made of an operation of the image data dispensing system in case where access managing means 421 executes above-mentioned function 2, referring to the flowchart (steps S41 through S53) of FIG. 5.

As steps S41 through S46 are similar to steps S21 through S26 of FIG. 4, so their detailed description is omitted here.

Subsequently to step S46, or if it is decided that the customer has his/her own reserved area in step S45 (YES route), reference image producing means 422 produces a reference image (step S47), which is then registered/stored, together with the object image data, in image database 41 (step S48). The service provider carries out access settings such that the customer can access the reference images freely, whereas, regarding their original image data, security settings are made such that a predetermined access key is essential for accessing the original image data.

The customer accesses image server 40 of the service provider from customer terminal 60 via communication network 50 to see a reference image, and decides whether or not to download its original image data.

After that, if consideration collection managing means 423 confirms the payment for the image data by the customer (YES route of step S49), the downloading of the image data is permitted (step S50). More precisely, after an access key for accessing the image data is notified to the customer, if server manager 42 certifies an access key received from the customer, it permits the customer to access the image data.

Once a piece of image data is downloaded by a customer, the image data is no longer required to be stored in image database 41, and hence image deleting means 424 deletes such a image data from image database 41 with elapse of a predetermined period (step S51).

On the other hand, the image data that has not been downloaded by a customer is thought to be useless to the customer. Consideration collection managing means 423 hence evaluates whether or not the charge-uncollected period exceeds a predetermined period (step S52), and then if it is evaluated that the charge for the image data has not yet been collected even after elapse of a predetermined time period, image deleting means 424 deletes the image data from image database 41 (from YES route of step S52 to step S53).

In this manner, according to the second embodiment, image data upon which predetermined data manipulation has been performed is stored in image server 40 and dispensed to customers through communication network 50, with no use of external medium 30, which is essential in the first embodiment. It is thus possible for a service provider to minimize the charge for the image data dispensing service.

Further, utilizing above-mentioned function 1 of access managing means 421, a service provider allows a customer to access the image data stored in the image server 40, from customer terminal 60, only during a certain limited period depending upon the amount of charge the customer has paid. Hereby it is possible for the service provider to earn a charge (server managing charge) for storing and managing the image data in the image server 40.

Still further, utilizing above-mentioned function 2, a service provider permits a customer to access (download) the image data stored in the image server 40, from customer terminal 60, upon the payment of a predetermined charge made by the customer. Hereby it is possible for the service provider to collect a charge for the image data at its being downloaded.

Furthermore, reference image producing means 422 produces a reference image (an image of lower quality than the original one: thumbnail, for example) of the original image data stored in the image server 41, and the reference image is offered to a customer without charge. Hereby it is possible for the customer to decide whether or not to download the image data, referring to the reference image. In other words, the customer is able to download only preferred images, referring to such reference images.

Since the reference images are of low quality barely enough to know what the original images are like, the reference images themselves are not so useful to customers. It is possible for the service provider to make a customer decide whether or not to purchase a picture image, without providing the original image data itself to the customer. Moreover, since such reference images are small in file size, they yield an advantage of saving the storage capacity of image database 41.

And further, utilizing the functions of consideration collection managing means 423 and image deleting means 424, it is possible to automatically delete the image data whose charge has not yet been paid even after elapse of a predetermined period, from image database 41. That is, the image data which has been left in image database 41 without being downloaded, is considered to be useless to both the customer and the service provider. Hence retention periods, during which image data is preserved in image database 41, are determined, one for each picture image, and the retention period-expired data is deleted, thereby automatically removing unnecessary image data, so that the storage area of image database 41 is saved and used effectively.

### [3] Third Embodiment

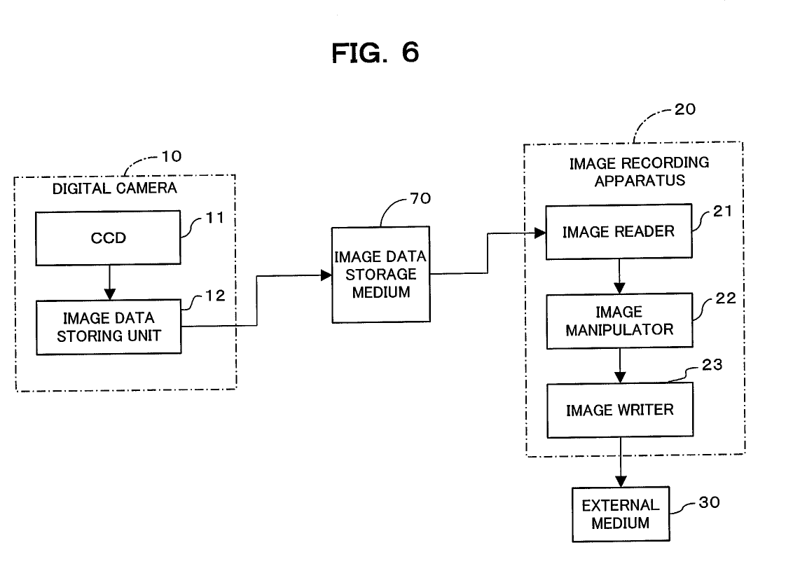

FIG. 6 is a schematic of an image data dispensing system of a third embodiment of the present invention. As shown in FIG. 6, the image data dispensing system of the third embodiment, like that of the first embodiment, includes digital camera 10 and image recording apparatus 20, and it additionally includes image data storage medium 70. In this instance, like reference numbers to those which have already been described designate similar parts or elements, so their detailed description is omitted here.

In the third embodiment, digital camera 10 may be lent by a service provider or may be owned by a customer, or else, may be fixedly installed in predetermined a position in a recreation facility, such as a theme park and an amusement park (hereinafter called an amusement park or, simply, a park). In this embodiment, what is lent to a customer by a service provider is image data storage medium 70.

Image data storage medium (image data storing apparatus) 70, which is a portable external storage device (hard disc unit) that temporarily stores the image data transmitted from digital camera 10, is connected with the digital camera 10 through, say, a USB. Image data storage medium 70 is connected with image recording apparatus 20 also through a USB so as to transfer the image data stored in the image data storage medium 70 to the image recording apparatus 20.

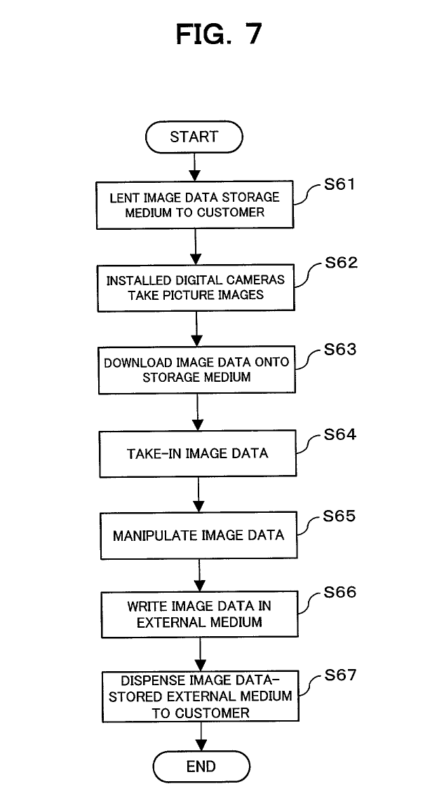

A description will now be made hereinbelow of an operation of an image data dispensing system of the third embodiment, with reference to the flowchart (step S61 through step S67) of FIG. 7.

In the third embodiment, if a customer brings about his/her own digital camera 10, or if digital cameras 10 are fixedly installed in a park, a service provider lends/provides image data storage medium 70 to the customer as a memory/external storage device (step S61). At that time, if the user wishes so, a digital camera 10 is lent to the customer.

The customer takes picture images, using any one of the customer's own digital camera 10, the one that is being lent, and the ones that are fixedly installed in the park (step S62). The customer connects image data storage medium 70 with the output terminal of the digital camera 10 through a USB, and then downloads the image data stored in image data storing unit 12 of the digital camera 10 to the image data storage medium 70 (step S63).

When the image data storage medium 70 is returned, a service provider connects the image data storage medium 70 with image recording apparatus 20, and image reader 21 then fetches the image data stored in the image data storage medium 70 (step S64). After that, image manipulator 22 performs predetermined data manipulation upon the image data (step S65), and image writer 23 writes the image data in external medium 30 (step S66). The external medium 30 is sold/dispensed to the customer (step S67) for a predetermined charge (consideration).

In this manner, with an image data dispensing system of the third embodiment, it is possible to realize a brand-new service. In the service, image data storage medium 70 is lent to a customer so as to temporarily store the image data obtained by digital camera 10 therein. The image data stored in the image data storage medium 70 is subjected to predetermined data manipulation and then provided to the customer for a consideration.

Hereby, it is not only possible to attain the similar effects or profits to those in the first embodiment, but also possible for a customer to use an image data storage medium 70 having a required capacity at a low cost, with no need for purchasing any expensive image storing memory for use in digital camera 10, nor any storage device externally equipped thereto, thereby eliminating the cost required for increasing the memory. Moreover, it is also possible to obtain a great amount of image data upon which the predetermined data manipulation has been performed. Meanwhile, from a service provider's point of view, it is possible to earn a rental of such image data storage medium 70.

Further, if digital cameras 10 are fixedly installed at predetermined positions in a park, it is necessary for a customer to carry only an image data storage medium 70, thus freed from carrying a digital camera 10. Image data obtained by the above fixedly installed digital cameras 10 is accumulated in the image data storage medium 70. By employing such an image data dispensing system in recreation facilities or tourist attractions, it is possible for a service provider to provide customers with digital image data upon which predetermined manipulation has been performed, with no use of any printing apparatus nor photographic paper sheets, thereby eliminating the cost for the printing apparatus and running costs such as that for the paper sheets, resultantly minimizing the amount charged to customers. From the customers' standpoints, since the image is provided in the form of digital data, it is possible to facilitate a secondary use of the provided digital image data.

Here, the image data may be transferred from in-park installed digital camera 10 to image data storage medium 70 via a radio communication interface instead of a USB. In this case, each of the digital cameras 10 and the data storage media 70 has a transceiver that is capable of communicating within a predetermined area, and the image data is automatically transferred from the digital cameras 10 to the image data storage medium 70 that is carried by a customer. For example, a digital camera 10 is installed inside of an attraction, such as a roller coaster, and a transmitter dedicated to image data transferring is installed at the exit of the attraction. With this construction, it is possible for a customer to store the image data, which has been taken at the attraction, into the image data storage medium 70 the customer carries, without making any special operation.

### [4] Fourth Embodiment

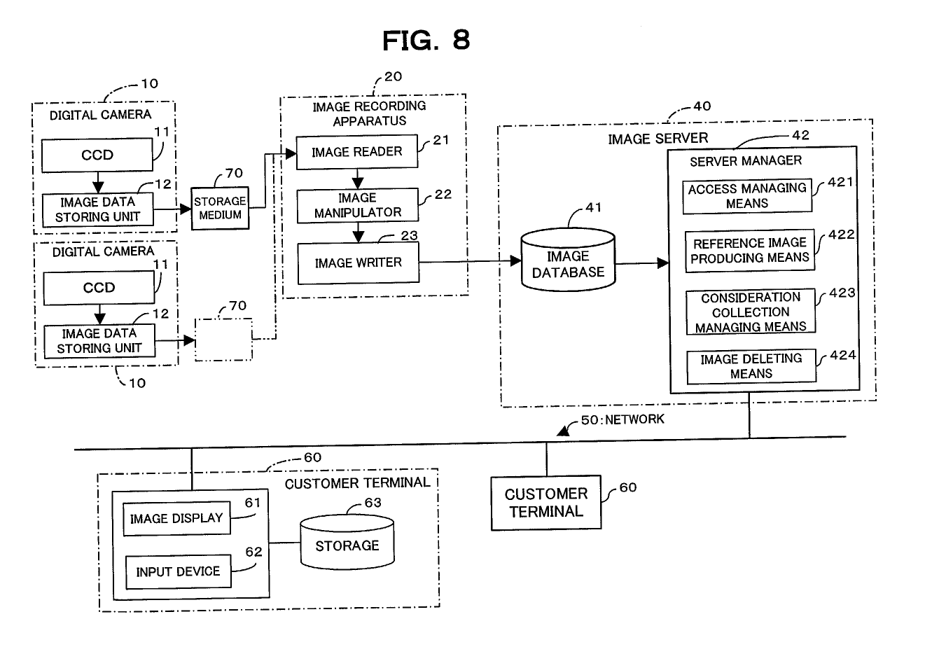

FIG. 8 is a schematic of an image data dispensing system of a fourth embodiment of the present invention. As shown in FIG. 8, the image data dispensing system of the second embodiment, which is a combination of the above second embodiment and the third embodiment, includes digital camera 10, image recording apparatus 20, image server 40 connected with communication network 50, and image data storage medium 70. In this instance, like reference numbers to those which have already been described designate similar parts or elements, so their detailed description is omitted here.

In comparison with the third embodiment, in which the image data is stored in an external medium 30, which is to be purchased by a customer, the image data is stored, in the fourth embodiment, in image server 40, and a customer receives the image data via communication network 50 such as the Internet. In other words, image server 40 and communication network 50 make up an image data dispensing means, as in the second embodiment.

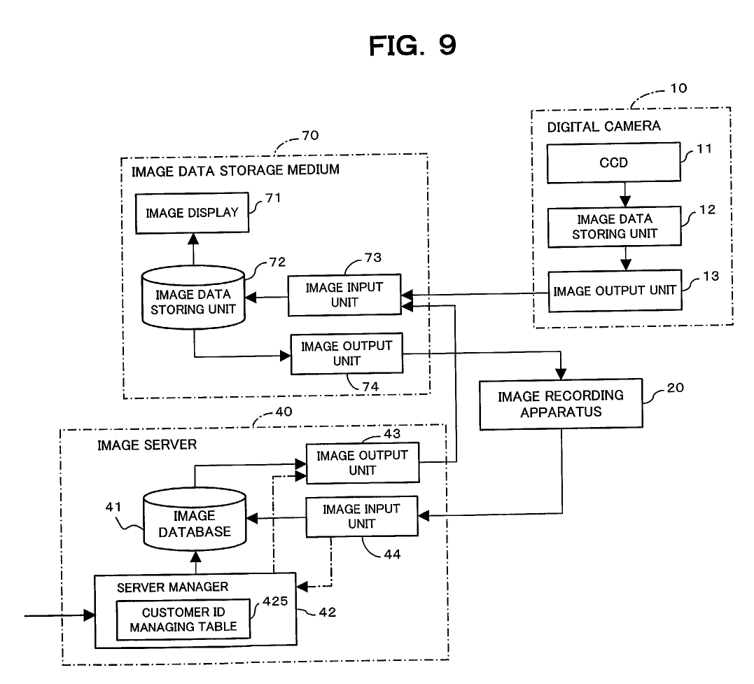

FIG. 9 depicts a schematic of the substantial part of the image data dispensing system of the fourth embodiment. In the fourth embodiment, image data storage medium 70 is formed in such a fashion as shown in FIG. 9.

Image data storage medium 70 includes image display 71, image data storing unit 72, image input unit 73, and image output unit 74. Image data obtained by CCD 11 of digital camera 10 is input to image input unit 73 via image data storing unit 12 and image output unit 13, and then stored in image data storing unit 72. Image display 71 shows the image data stored in image data storing unit 72 on its screen.

Image server 40 has image output unit 43 and image input unit 44 as well as image database 41 and server manager 42. As described in the third embodiment, image server 40 stores the image data that is received from image data storage medium 70 via image recording apparatus 20. Image data storage media 70 are prepared, one for each customer, basically, while image server 40 is shared among more than one user.

Accordingly, in order to keep the correspondence between each customer and the customer's image data, when inputting image data from image data storage medium 70 to image server 40 via image recording apparatus 20, a customer also inputs a customer ID through an input device (not shown) such as a keyboard. Being triggered by an image input signal, server manager 42 verifies the customer ID against customer ID managing table 425.

That is, server manager 42 verifies an input customer ID using customer ID managing table 425, thereby determining in which storage area of image database 41 the object image data is to be stored. In accordance with the customer information that is received from customer ID managing table 425, image database 41 stores the object image data, which is input from image input unit 44, in the storage area prepared for the customer.

More precisely, image database 41, which is an external storage device such as a hard disc unit, prepares directories, one for each customer, whose directory names each are identical to customer IDs, and image data of a customer is stored in a directory with the directory name identical to the customer's ID. On the basis of an input customer ID, server manager 42 selects the corresponding one of the directory names, making reference to customer ID managing table 425, and then instructs image database 41 to store the image data in the selected directory.

Next, an operation for storing the image from image server 40 to image data storage medium 70 will now be described hereinbelow. A customer inputs a customer ID through an input device (not shown) such as a keyboard. Server manager 42 verifies the input customer ID against customer ID managing table 425, and acknowledges the object customer's data storage area of image database 41. The server manager 42 then instructs image output unit 43 to output whole the image data stored in the user's data storage area to image data storage medium 70. At that time, the customer may select the image data to be output, by some operations from an input device such as a keyboard.

In image data storage medium 70, image data received from image server 40, like the output from digital camera 10, is stored in image data storing unit 72 by image input unit 73. In the fourth embodiment, when image data storage medium 70 is lent to a customer for the first time, the customer stores picture images that are taken by digital camera 10 in image data storage medium 70, and when the image data storage medium 70 is returned, the customer saves whole the image data to image server 40. And later, when image data storage medium 70 is lent to the customer next time, the previous image data having already been stored in the image server 40 is restored in the image data storage medium 70. Hereby, it is possible for a customer to obtain the image data of the past at every time when image data storage medium 70 is lent to the customer.

In case where image data storing unit 72 of image data storage medium 70 has only a limited amount of storage capacity, such image server 40 and image data storage medium 70 as those shown in FIG. 9 can be employed, so that image server 40 stores whole the image data a user has taken, while image data storing unit 72 of image data storage medium 70 holds only required image data selectively.

In FIG. 9, image recording apparatus 20 is connected between image output unit 74 of image data storage medium 70 and image input unit 44 of image server 40, and the image data can be sent from image output unit 43 of image server 40 to image input unit 73 of image data storage medium 70, also by way of image recording apparatus 20. Alternatively, image data storage medium 70 may be directly connected with image server 40 through an interface (an USB or others).

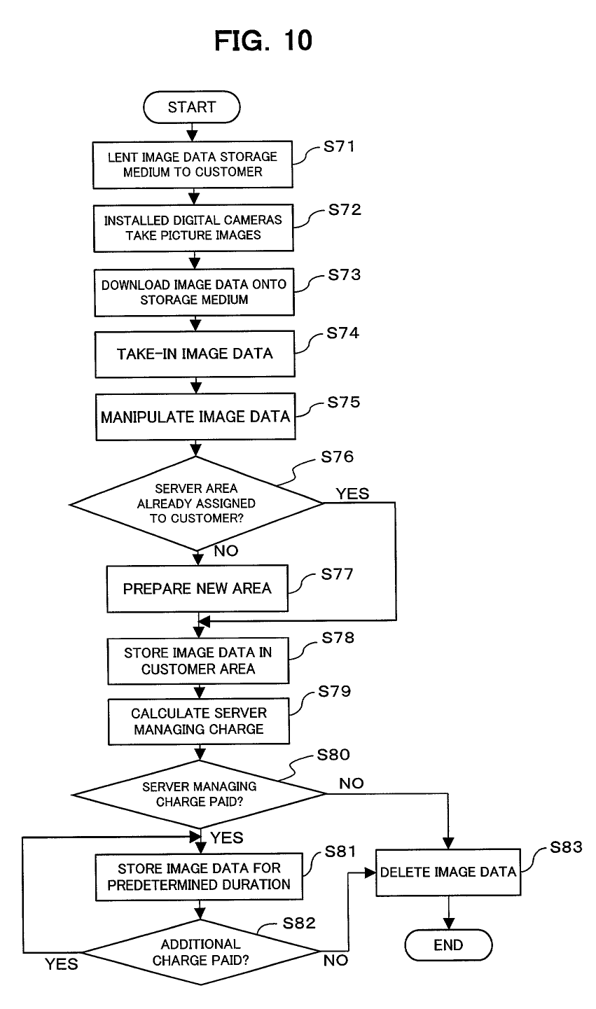

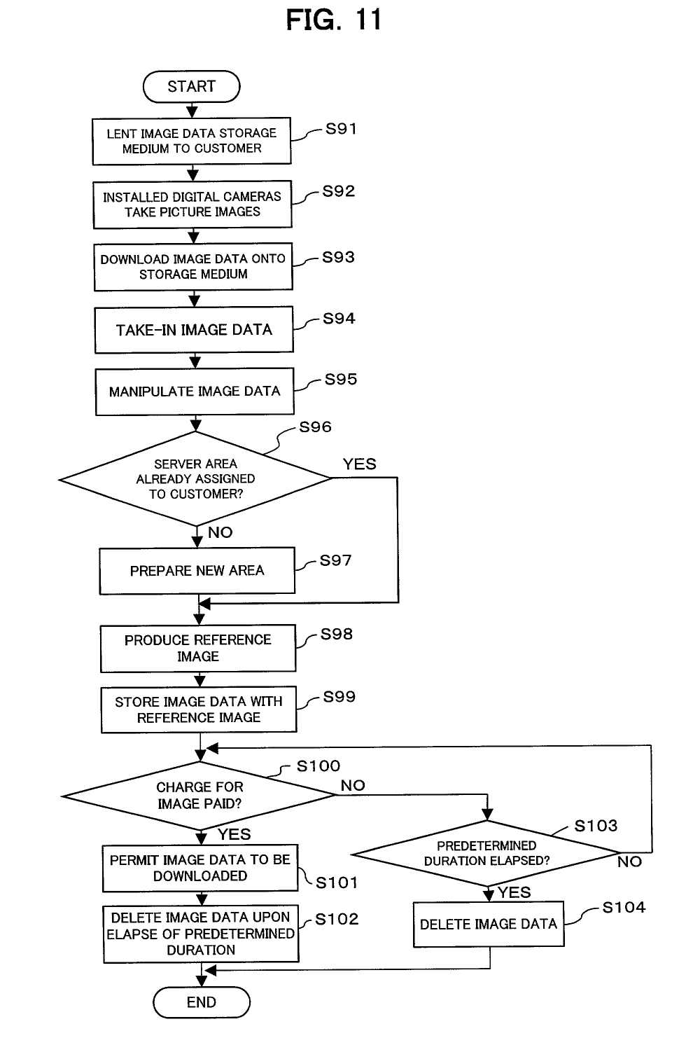

Next, a description will now be made hereinbelow of an operation of an image data dispensing system of the fourth embodiment, with reference to FIG. 10 and FIG. 11.

Firstly, a description will be made in case where access managing means 421 executes above-described function 1, with reference to the flowchart (steps S71 through S83) of FIG. 10.

Like in the third embodiment, a service provider lends/provides digital camera 10 to a customer (step S71).

The customer takes picture images, using any one of the customer's digital camera 10, the one that is being lent, and the ones that are fixedly installed in the park (step S72). The customer connects image data storage medium 70 with the input terminal of the digital camera 10 via a USB, and then downloads the image data stored in image data storing unit 12 of the digital camera 10, to the image data storage medium 70 (step S73).

When the image data storage medium 70 is returned, a service provider connects the image data storage medium 70 with image recording apparatus 20, and image reader 21 then fetches the image data stored in the image data storage medium 70 (step S74). After that, image manipulator 22 performs predetermined data manipulation upon the image data (step S75).

Subsequently, server manager 42 evaluates whether or not the object customer, whose image data is now being stored, reserves his/her own storage area in image database 41 (step S76), making reference to the above-described customer ID managing table 425. If the evaluation yields a negative result (NO route of step S76), image writer 23 creates a new area for the customer in image database 41 (step S77), and then writes and stores the image data in the newly created storage area (step S78). Otherwise if the evaluation yields a positive result (YES route of step S76), image writer 23 writes and stores the image data in the existing preserved area for the customer (step S78).

As steps S79 through S83 are similar to steps S28 through S32 of FIG. 4, so their detailed description is omitted here.

Secondly, a description will be made of an operation of the image data dispensing system in case where access managing means 421 executes above-mentioned function 2, making reference to the flowchart (steps S91 through S104) of FIG. 11.

As shown in FIG. 11, steps S91 through S97 are similar to steps S71 through S77 of FIG. 10, respectively, and steps S98 through S104 are similar to steps S47 through S53 of FIG. 5, respectively, so their detailed description is omitted here.

According to the image data dispensing system of the fourth embodiment, it is possible to attain the similar effects or profits to those in the second and third embodiments.

### [5] Fifth Embodiment

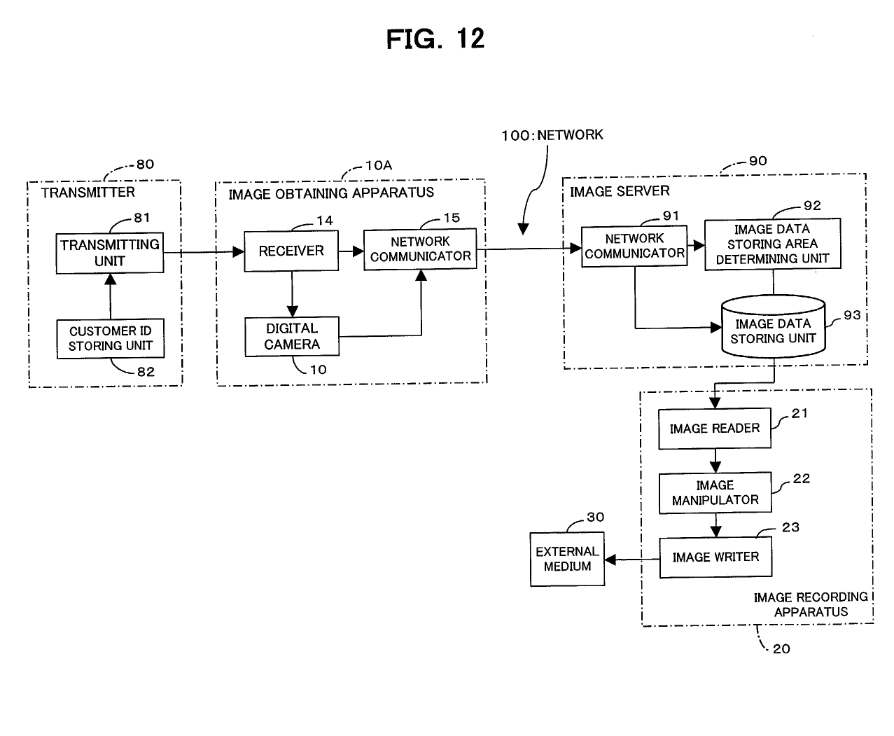

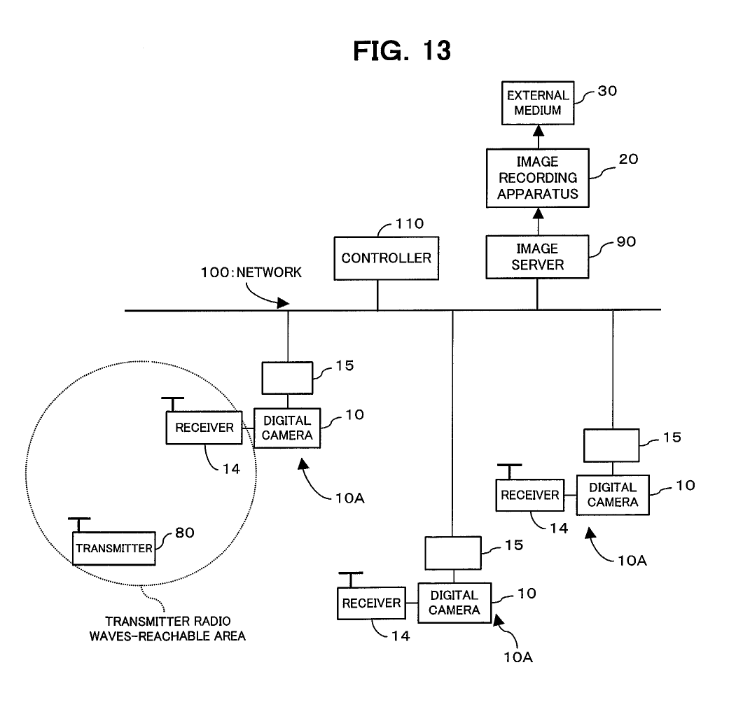

FIG. 12 is a schematic of an image data dispensing system of a fifth embodiment of the present invention. FIG. 13 is a schematic of the entire structure of the image data dispensing system of the fifth embodiment with that of FIG. 12 inclusive. The image data dispensing system of the fifth embodiment, as shown in FIG. 12 and FIG. 13, includes transmitter 80, image obtaining apparatus 10A, image server 90, communication network 100, and controller 110 (see FIG. 13), as well as above-described image recording apparatus 20. In FIG. 12, like reference numbers to those which have already been described, designate similar parts or elements, so their detailed description is omitted here.

Transmitter 80, which sends a signal containing an ID (identification information) unique to each customer, is lent to a customer. Transmitter 80 includes transmitting unit 81 and customer ID storing unit 82, which holds the information (customer ID) identifying the customer who carries the transmitter 80. Whenever image obtaining apparatus 10A (digital camera 10) takes a picture image, a signal containing the customer ID, which is held in customer ID storing unit 82, is sent from transmitting unit 81 in an automatic manner or by some predetermined operations. In this example, the serial number of transmitter 80 serves as a customer ID. The customer name and the date and time are written down in association with the serial number of transmitter 80 when it is lent to a customer. Transmitter 80 sends a signal that can travel only a short distance, say, 1 m through 2 m.

Image obtaining apparatus 10A, which includes receiver 14 and network communicator 15 as well as above-described digital camera 10 of the first embodiment through the fourth embodiment, is installed in advance in a predetermined position in a park, like in the third embodiment. Receiver 14 receives a signal from a transmitter 80 that stays in an area within which picture-taking by digital camera 10 is available. Upon receipt of the signal from transmitter 80 by receiver 14, digital camera 10 takes a picture, or obtaining image data. Network communicator 15 functions as an interface with communication network 100.

Image server 90, which includes network communicator 91, image data storing area determining unit 92, and image data storing unit 93, functions as an image data storing apparatus that temporarily stores the image data obtained by image obtaining apparatus 10A. Network communicator 91 serves as an interface with communication network 100. Image data storing area determining unit 92 determines the storage area of image data storing unit 93 in which the image data received from image obtaining apparatus 10A is now to be stored, following such a technique (using customer ID managing table 425) as described in the fourth embodiment with reference to FIG. 9.

Communication network 100 communicably connects image obtaining apparatus 10A and image server 90, so that image data and a customer ID can be transmitted from image obtaining apparatus 10A to image server 90.

Controller 110, as shown in FIG. 13, controls one or more image obtaining apparatus 10A, and is connected with such image obtaining apparatus 10A via communication network 100.

Image recording apparatus 20 of the fifth embodiment is constructed in a like manner to those in the first and the third embodiments. In the fifth embodiment, when transmitter 80 is returned, a particular storage area that corresponds to the transmitter 80 is specified in image data storing unit 93 based on the customer ID of the transmitter 80, and the image data stored in the thus specified area is read out by image reader 21. After predetermined data manipulation is performed upon the read-out image data, the data is written in external medium 30 by image writer 23.

In case where such an image data dispensing system of the fifth embodiment is installed in a park, a service provider keeps hundreds to thousands of transmitters 80 to lend to customers, and image obtaining apparatus 10A equipped with receiver 14 are fixed/installed at one or more positions in the park. Image server 90 and controller 110 each are installed at one particular place in the park.

A description will now be made hereinbelow of an operation of an image data dispensing system of the fifth embodiment, with reference to the flowchart (step S111 through step S116) of FIG. 13.

Transmitter 80 is lent/provided to a customer (step S111). Picture images of the customer are taken by means of transmitter 80 that is being lent and digital camera 10 (image obtaining apparatus 10A) fixedly installed in the park (step S112).

Here, receiver 14 of image obtaining apparatus 10A should be placed near digital camera 10 in an unnoted fashion: for example, on the backside of a bench prepared for customers' rest. Upon some predetermine operation made by a customer who is seated on the bench, transmitter 80 sends a photo-shooting signal (electric wave) containing its unique customer ID. Upon receipt of the signal by receiver 14, digital camera 10 takes a picture of a predetermined place (bench) in accordance with a signal from the receiver 14. At that time, the signal received by receiver 14 can be notified to controller 110 through network communicator 15 and communication network 100, which controller 110 then instructs the digital camera 10 to carry out photo-shooting.

The image data obtained by digital camera 10 is transmitted, together with the customer ID given from transmitter 80, to image server 90 through network communicator 15 and communication network 100, and stored therein, in the customer ID-corresponded storage area (step S113).

At that time, network communicator 91 of image server 90 receives the image data and the customer ID from image obtaining apparatus 10A, and the customer ID thus obtained is sent to image data storing area determining unit 92, which then determines a storage area where the image is to be stored in image data storing unit 93, according to the customer ID. In concrete, an ID number of “customer ID plus year, month, and day (of the lending of the transmitter 80)” is produced, and the ID number is used as a directory name (file name), under which the image data is finally stored. As each transmitter 80 is arranged to be lent to only one single customer per day, “customer ID plus year, month, and day” can serve as a customer-identifiable ID number that is unique to the customer. Image data storing unit 93 then stores the image data, which is received from network communicator 91, in the storage area determined by image data storing area determining unit 92.

At the time of the returning of transmitter 80, the service provider provides the customer with the image data stored in image data storing unit 93 in the following way, using image recording apparatus 20. That is, a particular storage area that has been prepared for the returned transmitter 80 in image data storing unit 93 is selected/specified based on the customer ID of the transmitter 80, and the image data stored in the thus specified area is read out by image reader 21 and then subjected to predetermined data manipulation made by image manipulator 22 (step S114). The thus manipulated image data is written by image writer 23 in external medium 30 (step S115), which is then sold/provided to the customer for a predetermined charge (consideration) (step S116).

In this manner, an image data dispensing system of the fifth embodiment accomplishes a brand-new service. In the service, a transmitter 80 is lent to a customer, and in response to a signal received from the transmitter 80, image obtaining apparatus 10A obtains image data. After being subjected to predetermined data manipulation, the resulting image data is then dispensed to the customer for a consideration.

Since it is required for a customer to carry only a transmitter 80, freed from carrying a digital camera 10 or an image data storage medium 70, for obtaining desired image data upon which predetermined data manipulation has been performed, the similar effects and profits to those in the third embodiment can be attained.

At that time, the image data obtained by digital camera 10 is transmitted, together with the customer ID received from transmitter 80, to image server 90 via a communication network 100, and then dispensed to a customer corresponding to the customer ID.

Provided that such an image data providing system is employed in a recreation facility or a tourist attraction, it is no longer required to prepare any output terminal dedicated to the downloading of the image data, one for each digital camera 10, thereby reducing the cost for the implementation of the system. Additionally, it is possible for customers, without making any particular operation, to receive the digital image data, which is taken by digital camera 10, in the form of being stored in external medium 30, at some predetermined wickets when the customers leave the facility.

### [6] Sixth Embodiment

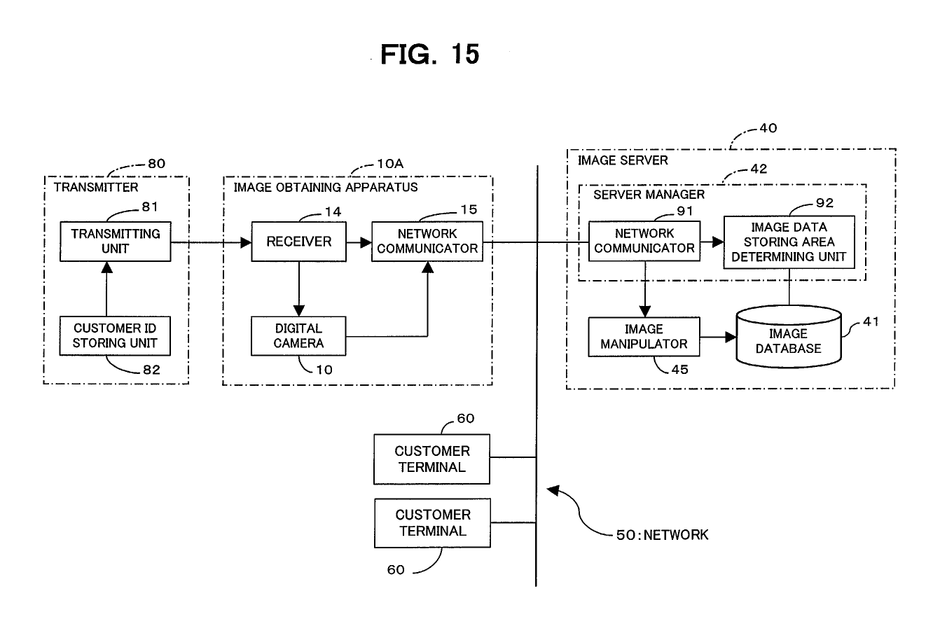

FIG. 15 is a schematic of an image data dispensing system of a sixth embodiment of the present invention. The image data dispensing system of the sixth embodiment, as shown in FIG. 15, is a combination of the second embodiment and the fifth embodiment, and includes not only transmitter 80, image obtaining apparatus 10A, and image recording apparatus 20, but also above-described image server 40 and communication network 50, which serve as image server 90 and communication network 100, respectively.

Here, image database 41 functions as image data storing unit 93, while server manager 42 functions as both network communicator 91 and image data storing area determining unit 92. Moreover, image server 40 functions as image manipulator 45, which performs predetermined data manipulation upon the image data that is received by network communicator 91 and is to be stored in image database 41.

In FIG. 15, like reference numbers to those which have already been described, designate similar parts or elements, so their detailed description is omitted here.

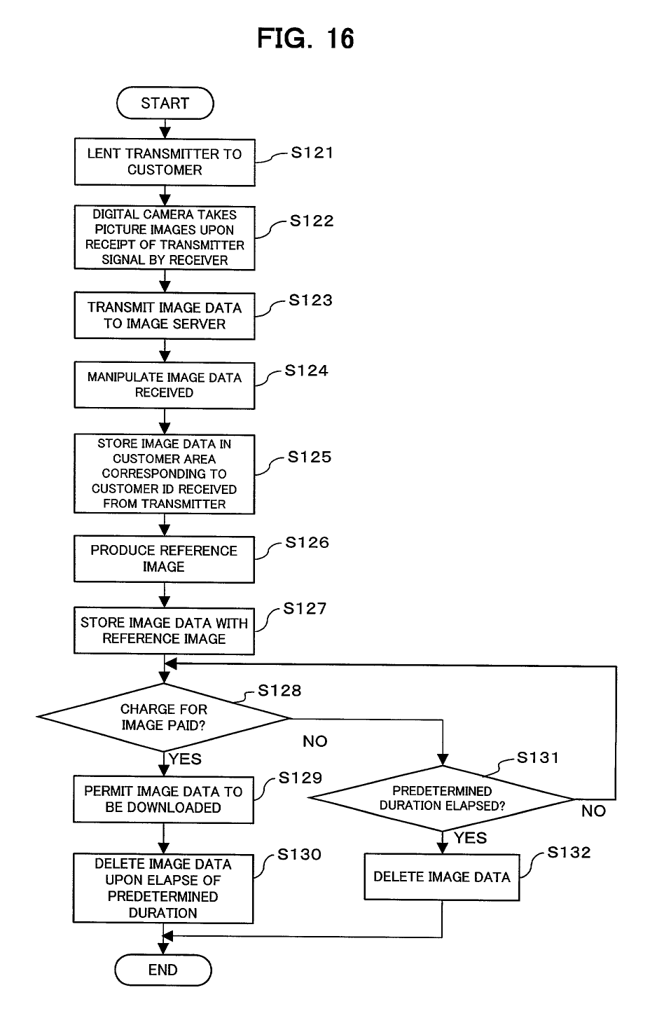

A description will now be made hereinbelow of an operation of an image data dispensing system of the sixth embodiment, with reference to the flowchart (step S121 through step S132) of FIG. 16. It is assumed that access managing means 421 carries out above-described function 2.

Transmitter 80 is lent/provided to a customer (step 5121). Picture images of the customer are taken by means of the transmitter 80 and digital camera 10 (image obtaining apparatus 10A) fixedly installed in the park (step S122). The image data obtained by digital camera 10 is transmitted, together with a customer ID received from transmitter 80, to image server 40 through network communicator 15 and communication network 50 (step S123).

The image data received by network communicator 91 is subjected to predetermined data manipulation by image manipulator 45 (step S124). Image data storing area determining unit 92 determines a storage area in which the image is to be stored in image database 41, according to the customer ID of transmitter 80, and the resulting image data of data manipulation is then stored in the determined storage area (step S125)

As steps S126 through S132 are similar to steps S47 through S53 of FIG. 5, so their detailed description is omitted here.

In this instance, assuming access managing means 421 carries out above-described function 1, it is possible to perform step S27 through step 32 of FIG. 4 in place of step S126 through step S132.

According to the image data dispensing system of the sixth embodiment, it is possible to attain the similar effects or profits to those in the second and fifth embodiments.

### [7] Seventh Embodiment

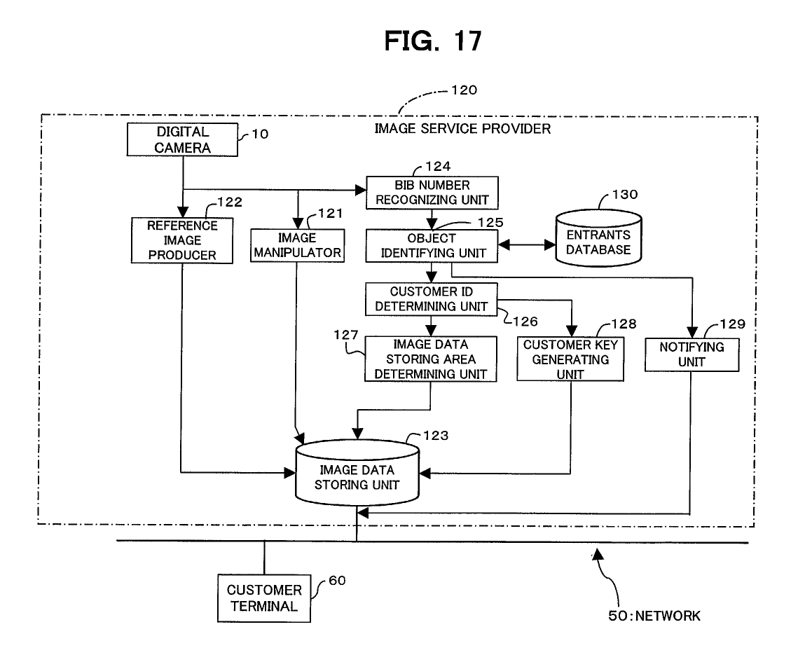

FIG. 17 is a schematic of an image data dispensing system of a seventh embodiment of the present invention. As shown in FIG. 17, the image data dispensing system of the seventh embodiment is formed as image service provider 120.

It is often possible to recognize who an object customer (the subject of the picture image) is based on the image data obtained by digital camera 10; athletic races, such as marathon, ekiden, triathlon, and road racing, would be good examples. Each of the athletes (entrants) who take part in such an athletic race is given a bib number (ID information) unique to each athlete, and wears a bib (number card) on which the bib number is printed. In general, athletes' bib numbers and their personal data (name, address, and others), in association with one another, are put on a entrants list or in a data base so as to be managed by the host of the race.

Accordingly, once their bib numbers are known, the names and addresses of the athletes can be also known. In other words, in case of picture images that are taken at such an athletic race, it is possible to specify the subject person of a picture image (to identify who the subject person of the image data is), by using the bib number the subject person is putting on her/him, even though the subject person carries no image data storage medium 70 nor transmitter 80.

Utilizing these facts, image service provider 120 of the seventh embodiment takes picture images of entrants of an athletic race (marathon or the like) with digital camera 10, in order to sell the picture images to the individual corresponding entrants. More precisely, the entrants who are specified by their bib numbers are notified that their picture images taken at the race are kept, by e-mail or something. The image data of the picture images is provided to the customers, if they so wish, at the payment of charges for image shooting.

For this purpose, image service provider 120 includes image manipulator 121, reference image producer 122, image data storing unit 123, bib number recognizing unit 124, subject identifying unit 125, customer ID determining unit 126, image data storing area determining unit 127, customer key generating unit 128, notifying unit 129, and entrants database 130, as well as digital camera 10.

Digital camera 10 is installed and fixed at a predetermined point and takes pictures of entrants of a race, in an automatic way, or by manual operations of a photographer. At that time, the pictures should be taken such that the number cards (bibs) the entrants are putting on themselves are contained in the picture images.

Image manipulator (image manipulating means) 121, which carries out similar functions to those of above-described image manipulators 22 and 45, performs predetermined data manipulation upon the image data obtained by digital camera 10.

Reference image producer (reference image producing means) 122, which carries out similar functions to those of above-described reference image producing means 422, produces a reference image (say, a thumbnail) for the image data that has been obtained by digital camera 10.

Image data storing unit 123, like above-described image server 40, carries out similar functions to those of a server connected with communication network 50. Image data storing unit 123 stores therein the image data, upon which reference image producer 122 has performed the predetermined data manipulation, in association with its reference image data, which is produced also by reference image producer 122. Further, image data storing unit 123 also functions as above-mentioned server manager 42, or namely, as access managing means 421, reference image producing means 422, consideration collection managing means 423, and image deleting means 424.

Bib number recognizing unit (ID information extracting means) 124 extracts and recognizes the number (bib number; ID information) for use in specifying a customer (entrant), from the image data obtained by digital camera 10. More specifically, bib number recognizing unit 124 extracts a number card image based on the background color of the number card (bib), and the extracted number card image is converted into a numerical form by OCR (Optical Character Reader), thereby recognizing the number.

Subject identifying unit (customer specifying means) 125 obtains the customer's personal data {name, address (e-mail address, for example), or any data which is unique to the customer} by retrieving entrants database 130 using the extracted number, which is extracted by bib number recognizing unit 124, as a key, and identifies the customer based on the thus obtained personal data. In this instance, entrants database 130 stores the bib number of each entrant and his/her personal data in association with one another. Such an entrants database 130 would be provided by the host of an athletic race or might be prepared based on an entrants list.

Customer ID determining unit 126 automatically generates a customer ID based on an entrant's data. Concretely, customer ID determining unit 126 generates a customer ID of “(race date) plus (race No. previously set for each race) plus (bib number)”. Such a customer ID would be still unique to each customer even if more than two races are held on the same day.

Image data storing area determining unit 127 determines the storage area of image data storing unit 123 in which the image data and its reference image are to be stored, based on the customer ID, which is determined by customer ID determining unit 126.

Customer key generating unit 128 generates a customer key which will be required for permitting a customer's downloading of the image data (described later).

Notifying unit (notifying means) 129 notifies the customer (customer terminal 60), who has been identified by subject identifying unit 125, that the customer's picture images that have been taken at the race are kept, and also of a technique for accessing the image data (including reference image-storing server information), by e-mail or something.

Notifying unit 129 and image data storing unit 123 are adapted to be connected with customer terminal 60 in a communicable manner via communication network 50 such as the Internet. The customer who has received the notification by notifying unit 129, is capable of obtaining the image data via communication network 50 for a predetermined consideration (described later). In short, in the seventh embodiment, image data storing unit 123 and communication network 50 form an image data dispensing means.

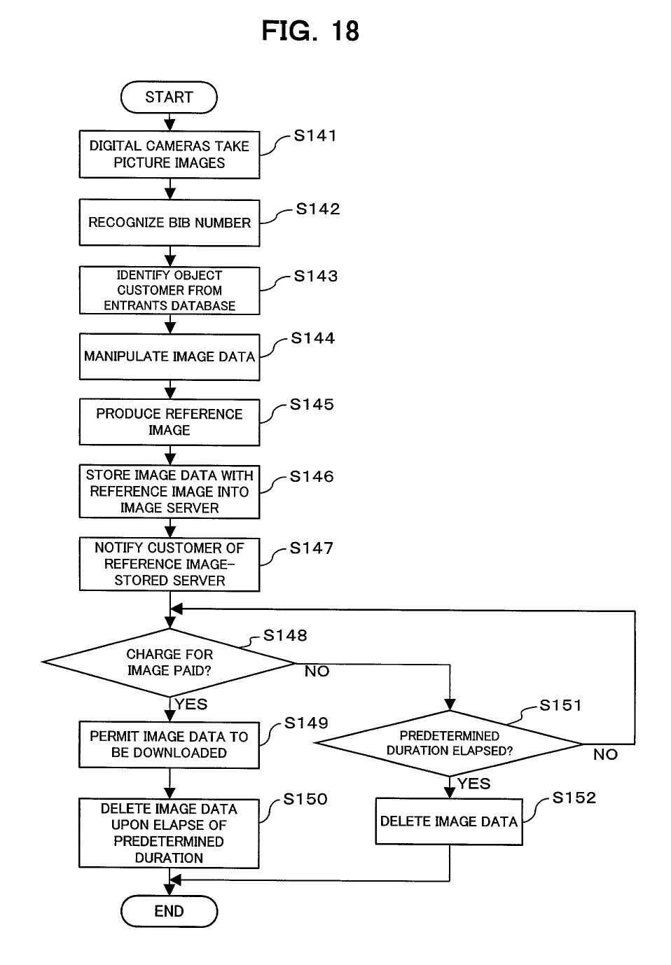

Next, a description will now be made hereinbelow of an operation of an image data dispensing system of the seventh embodiment, with reference to the flowchart (step S141 through step S152) of FIG. 18.

A service provider takes a picture of an entrant (customer) who takes part in a race with digital camera 10 (step S141). The image data obtained by digital camera 10 is sent to bib number recognizing unit 124, in which the number (bib number) of the subject person is extracted/recognized automatically or by manual operation (step S142).

Using the extracted number, which is extracted by bib number recognizing unit 124, subject identifying unit 125 retrieves entrants database 130 so as to obtain the personal data of the customer, thereby identifying/specifying who the customer is (step S143). At the time, customer ID determining unit 126 determines a customer ID unique to the object customer, based on the personal data of the customer, and image data storing area determining unit 127 then determines the storage area of image data storing unit 123 in which the image data is to be stored, based on the customer ID.

As a meantime, the image data obtained by digital camera 10 is sent also to image manipulator 121 and reference image producer 122. Image manipulator 121 performs predetermined data manipulation upon the image data (step S144), and at the same time, reference image producer 122 produces a reference image based on the image data (step S145).

The resulting image data, which is the result of the data manipulation, and the reference image are stored in the storage area (step S146), which is determined by image data storing area determining unit 127, in image data storing unit 123 that serves as a server connected with communication network 50. At this time, customer key generating unit 128 generates a customer key, which is then also stored in image data storing unit 123. Although reference images are viewed and downloaded at no charge, it is not possible to access their original image data without using a password, which is generated from the customer key.

After that, notifying unit (notifying means) 129 notifies the customer (customer terminal 60), who is identified by subject identifying unit 125, of a technique for accessing the image data (including reference image-storing server information), via communication network 50 (step S147).

In this example, communication network 50 is the Internet, and a system for providing image data stored in image data storing unit 123 is a WWW server. Like in the second embodiment, the service provider carries out access settings such that the customer can access reference images freely, whereas, regarding their original image data, security settings are made such that a predetermined access key is essential for accessing the original image data.

The customer accesses image data storing unit 123 of image service provider 120 from customer terminal 60 via communication network 50 to see/download the reference image, and decides whether or not to download its original image data.

After that, if consideration collection managing means 423 confirms the payment for the image data by the customer (YES route of step S148), the downloading of the image data is permitted (step S149) More precisely, like in the second embodiment, after notification of an access key (a customer key generated by customer key generating unit 128) for accessing the image data, if image data storing unit 123 verifies an access key received from the customer, it permits the customer to access the image data.

Once a piece of image data is downloaded by a customer, the image data is no longer required to be kept in image data storing unit 123, and hence image deleting means 424 deletes such a image data from image data storing unit 123 after elapse of a predetermined period (step S150).

On the other hand, the image data a customer has not downloaded is thought to be useless to the customer. Consideration collection managing means 423 hence evaluates whether or not the charge—uncollected period exceeds a predetermined period (step S151), and then if it is resultantly evaluated that the charge for the image data has not yet been collected even after elapse of a predetermined time period, image deleting means 424 deletes the image data from image data storing unit 123 (from YES route of step S151 to step S152).

In this manner, an image data dispensing system of the seventh embodiment accomplishes a brand-new service. In the service, image data that includes a customer's ID information in the form of a picture image is obtained, and the ID information extracted therefrom is used to specify one object customer (to identify who the customer is), to whom a technique for accessing the image data is then notified. The image data is dispensed to the customer for a consideration.

For example, in an athletic race, such as marathon, ekiden, triathlon, and road racing, to which an image data dispensing system (image service provider 120) of the seventh embodiment is applied, bib numbers unique to individual customers are extracted from the picture images for use in dispensing the image data to the corresponding customer, thereby attaining the similar effects and profits to those of the second, fourth, and sixth embodiments of the present invention.

Although e-mail is employed in notifying a customer of an accessing technique to the image data in the above example, the notification can be carried out alternatively by mail or by telephone. Additionally, though image dispensing is carried out via communication network 50 in the above example, the customer may visit a wicket to purchase an external medium (portable medium) that stores desired image data therein.

Further, in some athletic races (marathon, triathlon, and others) of these days, the entrants often wear tokens that send information unique to each entrant, for the purpose of accurate measurement of time records (split time, finish time, and so on). In this case, such tokens can be utilized to serve as transmitters 80 of the fifth and the sixth embodiments.

More precisely, if receiver 14 receives a signal from a token that is passing by image obtaining apparatus 10A, digital camera 10 automatically takes a picture of the entrant (customer) who wears the taken, and the entrant's unique data is also added to the image data as a customer ID. In this case, such an image data dispensing system as that of FIG. 12 or of FIG. 15 might be employed.

### [8] First Mode of Image Data Manipulation

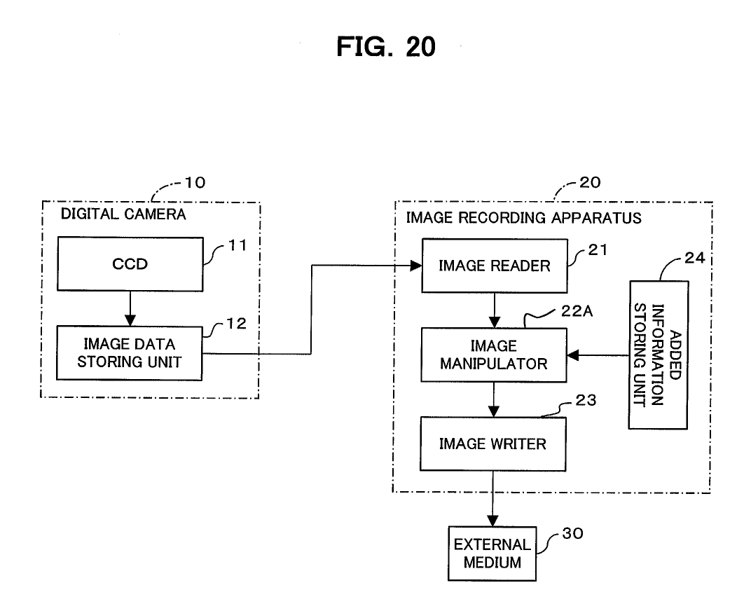

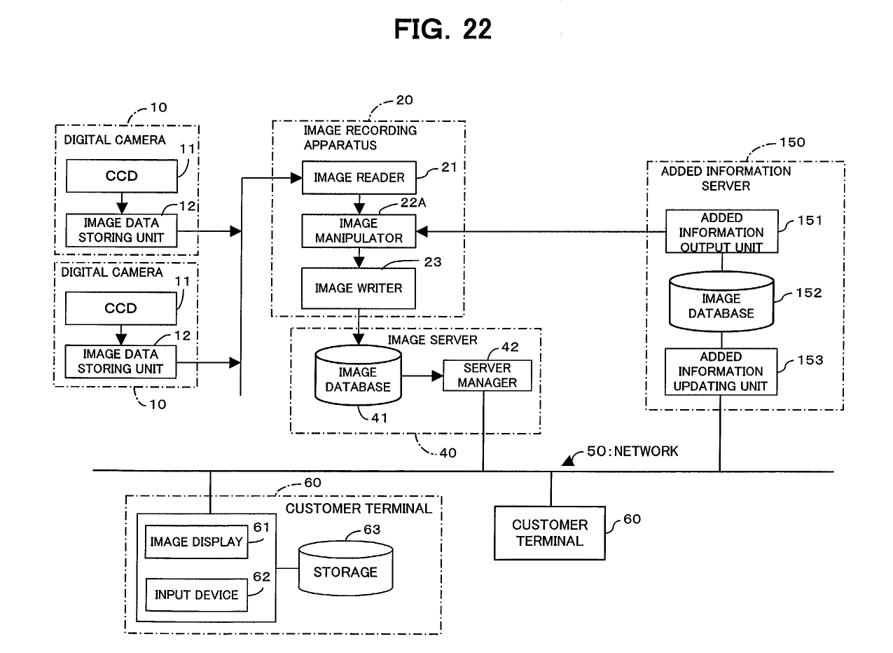

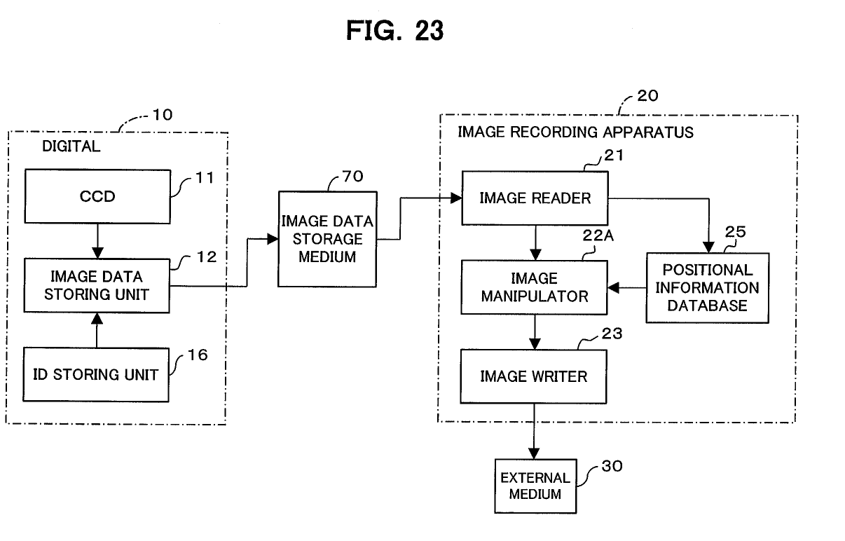

A description will now be made hereinbelow of a first mode of image data manipulation technique according to the above embodiments of the present invention, with reference to FIG. 19. In the first mode, above-described image manipulators 22, 45, and 121 store added information in a predetermined address of the object image data (see item 22A of FIG. 20, FIG. 22, and FIG. 23).

When storing image data in external medium 30, image server 40 or image server 123, a service provider stores predetermined data (added information) in an area other than that occupied by the image data itself, hereby making it possible for the customer to obtain the image data having the predetermined added information stored therein, without separately using or purchasing any dedicated device or software.

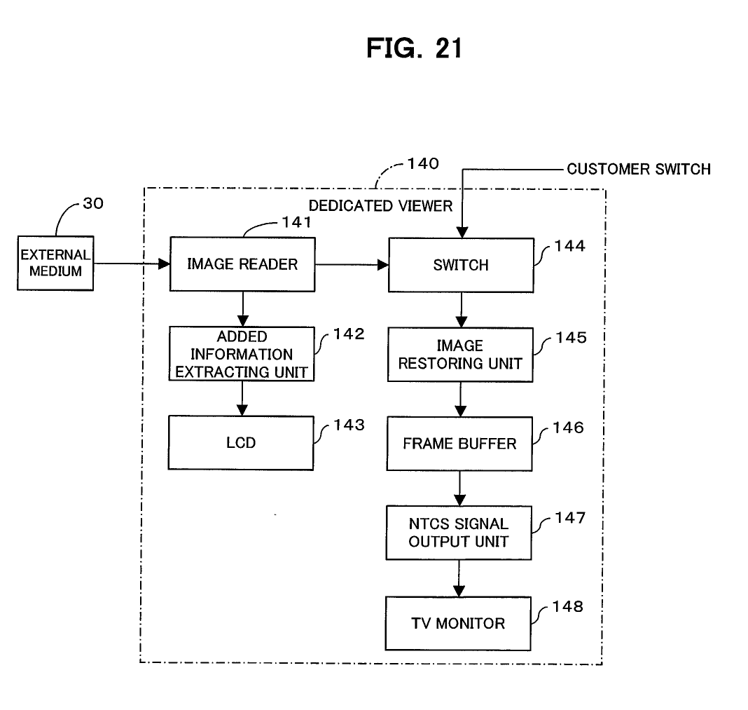

As shown in FIG. 19, a piece of image data is formed not only of an image data area, in which digital data of a picture image itself is stored, but also of another area (header area) storing relevant data, such as the date of creation of the image data, the number of pixels in longitudinal/horizontal directions, the file size, and others. In the above embodiments, added information, such as when and where the picture image was taken, who or what the subject is, who took the picture image, and some company advertisement information, is stored in a digitized form in a specific data storage area of the header area: for example, “month/date: at the fifth station of Mt. Fuji, with families, photo by Dad”. Using some software dedicated to the storing of such added information, the added information can be displayed concurrently with the image data (see dedicated viewer 140 of FIG. 21).

A JPEG, which is an international standard format of a static image, has a dedicated area (unique data storage area) for storing some arbitral data therein. Predetermined added information can be stored in this dedicated area, without impairing a fine JPEG format. Such a specific data storing area has been normally used to store the device name and the manufacturer name of digital camera 10.

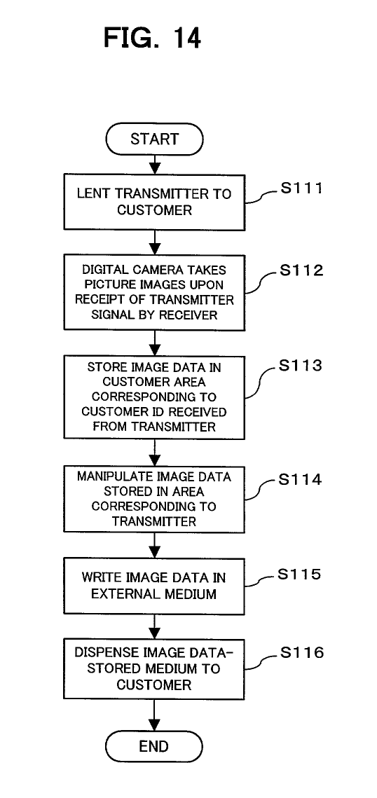

By using such an area for storing added information, even a type of software which is not adapted to the storing of added information can also be used for displaying the image data. For example, digital image printing devices installed at convenience stores would be able to display the added information, and customers can easily select the picture images they would like to printout with such a printing device. The above image data manipulation technique is applied to any one of the image data dispensing systems of FIG. 1 through FIG. 18, thereby making it possible for a service provider to collect the charge for storing added information into a header area.

### [8-1] First Example of the First Mode of Image Data Manipulation

FIG. 20 depicts a first example of an image data dispensing system according to any one of the above embodiments, to which system the first mode of image data manipulation technique is applied, while FIG. 21 depicts an image viewer employed in an image data dispensing system according to any one of the above embodiments, to which system the first mode of image data manipulation technique is applied. In the following description, the first example of the image data manipulation technique of the first mode is applied to an image data dispensing system of the first embodiment, and the first example is applicable also to image data dispensing systems of the above second through seventh embodiments. In FIG. 20, like reference numbers to those which have already been described designate similar parts or elements, so their detailed description is omitted here.

Image recording apparatus 20 of FIG. 20 includes not only image reader 21 and image writer 23 but also image manipulator 22A and added information storing unit 24. Image manipulator 22A corresponds to above-described image manipulator 22, and as described above with reference to FIG. 19, the predetermined data manipulation to be performed upon the image data is storing added information in a predetermined address of the image data. Added information storing unit 24 stores therein added information, which is to be written in the image data by image manipulator 22A.

For example, added information storing unit 24 stores therein added information such as “month/date:

at XXX Amusement Park”. Image manipulator 22A records the added information, which is stored in added information storing unit 24, into the image data. At that time, not only the information of where and when the image data was taken but also the image data-related personal data (descriptions of the photographer and the subject of the picture image, impression at photo-shooting, and others) of the customer whom the image data belongs to, might be stored as added information. In addition, a company advertisement (for example, “XXX Amusement Park: 50% OFF for admission on Christmas Eve!”) might be also stored as the added information.

In the first mode, the image data containing the added information is then stored in external medium 30, which is then dispensed to the customer. The customer can use, for example, dedicated viewer 140 of FIG. 21 to see the image data and the added information stored in external medium 30.

Dedicated viewer 140 reads out the added information, which is stored by image manipulator 22A, together with the image data, and shows the read-out data on its screen. As shown in FIG. 21, dedicated viewer 140 includes image reader 141, added information extracting unit 142, LCD 143, switch 144, image restoring unit 145, frame buffer 146, NTCS (National Television System Committee) signal output unit 147, and TV monitor 148.

Image reader 141 reads-in image data stored in external medium 30; added information extracting unit 142 extracts the added information from the read-in image, which has been read-in by the image reader 141. LCD (Liquid Crystal Display) 143, which is adapted to show a string composed of about 20 characters on its screen, shows the added information, which is extracted by added information extracting unit 142.

Switch 144 is operated by a customer, while the customer is referring to LCD 143, to switch ON/OFF the display of the mage data on TV monitor 148.

More precisely, the customer sees only the added information shown by LCD 143 to recognize what the image data read-out from external medium 30 is like, and thereby determines whether or not to display the image data on TV monitor 148. And then, the customer operates switch 144 through an externally equipped customer switch, thereby choosing whether or not to display the image data.

Image restoring unit 145, frame buffer 146, and NTCS signal output unit 147 are activated only when switch 144 is turned ON by the customer upon decision that the image data should be displayed based on the added information shown on LCD 143. Concretely, image restoring unit 145 restores the image data that is to be displayed on TV monitor 148, in frame buffer 146. NTCS signal output unit 147 converts the image data restored in frame buffer 146 into NTSC signals, and outputs the signals to TV monitor 148, and hereby the image data is displayed on TV monitor 148.

A more precise description will now be made hereinbelow of added information and a technique for displaying the added information.

In the first mode of image data manipulation, image manipulator 22A performs data manipulation upon the image data, or storing added information in the image data, before the image data is stored in external medium 30. At that time, image manipulator 22A stores added information in a predetermined address (an area in the header of a JPEG file, in which area a customer is able to store information arbitrarily) of the image data.

The added information can sometimes be an arbitrary string of characters designated by a customer (for example, “month/date: at the fifth station of Mt. Fuji, with families, photo by Dad”) Or, if an image data dispensing system according to any one of the above embodiments is employed in an amusement park, the added information may be an advertisement of the park (for example, “XXX Amusement Park: 50% OFF for admission on Christmas Eve!”).

As one example of a secondary use of the image data, it can be dispensed to third parties. As in the case where extra copies of a family photo are printed, one for each family member, the image data would be dispensed to third parties through the Internet or by e-mail. Digital data is more advantageous in its dispensing than a conventional camera's photo images, in that, the digital data can be delivered by e-mail with ease, and the cost for extra copies is no longer required. If a company advertisement is added to such image data, the advertisement is expected to be dispensed also to the customer's families or friends (anyone who is involved in a network of the customer's personal contacts).

When a customer dispenses image data to someone, the customer's own description is likely to be added, say, “I took this picture at XXX Amusement Park, their roller coaster was very thrilling and enjoyable”. This kind of subjective information, or so-called word of mouth, is highly counted on by most customers in the evaluation of companies. With an image data dispensing system of any one of the above embodiments, it is possible to make the image data, which is to be dispensed to a customer, contain the information its provider wish to propagate.

In the meantime, the company data stored in image the data may be formed of not only a string of characters but also a display-available period, during which the company data is to be shown by dedicated viewer 140.

In the above example, the company data was given as the message of “XXX Amusement Park: 50% OFF for admission on Christmas Eve!” This message will be useless after Christmas Day, and even if such a Christmas advertisement is shown in midsummer, say, in July, it would not appear so attractive for customers.

Accordingly, control data such as “11201224” is added to the above string of characters. The upper four digits of the control data designate the initial date of the display of the character string, while the lower four digits designate the final date. Namely, “11201224” instructs that the character string should be displayed from the 20^{th} of November through the 24^{th} of December. Hereby, it is possible for an amusement park to deliver an appropriate piece of information at an appropriated time period. In this example, the control code has only 8 digits, but in practical use, it is preferred to have 16 digits so as to include “year” information.

Further, such company data should by no means be limited to one type of information, and two or more types of information may be stored.

The followings are examples:

(A) “XXX Amusement Park: New Year party! From the 1^{st} to the 3^{rd} of January” 12250103;

(B) “XXX Amusement Park: No admission for school children or the younger on the 5^{th} of May!” 04010505;

(C) “XXX Amusement Park: 50% OFF for admission on Christmas Eve!” 11201224; and

(D) “XXX Amusement Park” 00000000.

The display of these example of the added information-containing image data on dedicated viewer 140 is as follows:

message (A) appears from the 25^{th} of December through the 3^{rd} of January;

message (B) appears from the 1^{st} of April through the 5^{th} of May;

message (C) appears from the 20^{th} of November through the 24^{th} of December; and

message (D) appears on the other dates than the above ones (“00000000” is a default value).

In the meantime, assuming that a customer who visits the park for the second time wants to use a previously purchased external medium 30, the customer hands it to the service provider, if the external medium 30 still has sufficient capacity, to make the image data of this time stored therein. At that time, the service provider earns the charge for the recording of the image data in the external medium 30, not for the external medium 30 itself. Otherwise if no sufficient storage capacity is left in the external medium 30, the image data is stored in another external medium 30, which is then purchased by the customer.

If a customer revisits a park and uses the external medium 30 that has been purchased previously, the image data once dispensed to the customer is returned to the service provider, which flow would be cycled. At the returning of the image data, it is possible for the service provider to update the company data stored in the external medium 30. More precisely, the service provider checks the company data added to the image data in external medium 30, so as to update the company data if it is not the latest one. This function can be utilized also when the latest image data is stored in an existing customer-dedicated storage area of image database 41. This will be described later in detail with reference to FIG. 22.

Dedicated viewer 140 of FIG. 21 is realized by a software tool operates on a personal computer, or otherwise by a combination of a dedicated hardware tool and a software tool. Dedicated viewer 140 has LCD 143 for showing added information thereon, and also TV monitor 148 for showing image data. Both the added information and the image data may be shown alternatively on one and the same screen, separately in tiled windows or overlaid windows. At that time, since some of the customers might feel such company data annoying, dedicated viewer 140 is preferred to have a function (switch 144) of switching ON/OFF the display of the company data.

As described above, since image manipulator 22A, as predetermine data manipulation, stores the added information in a predetermined address of the image data, it is possible for a customer, while referring to the image data itself, to refer also to the added information, so that various information can be obtained at the same time. At that time, the use of dedicated viewer 140 would facilitate the display of both the image data and the added information on LCD 143 and TV monitor 148.

Further, since an advertisement (company data, or else) relevant to where the image data has been obtained can be stored in a predetermined address of the image data as added information, it is possible to dispense the advertisement information not only to an object customer, but also to third parties (anyone who is involved in a network of the customer's personal contacts: the customer's acquaintances, for example) who would receive and see the image data transferred from the customer. Such advertisement information is expected to significantly contribute to increase in repeat customers and new customers.

At that time, partly since a display-available period, during which the added information is shown, can be designated by the service provider, and partly since dedicated viewer 140 is adapted to show the added information only during the display-available period, it is possible to make dedicated viewer 140 show advertisement information only for a limited period (for which the advertisement is valid) as the service provider wishes.

Further, if it is found, at the time of storing the latest image data, that any other image data has been previously stored in the external medium 30 in which the latest data is now to be stored, it is possible to replace the old advertisement stored in the previous image data with the latest one, thereby updating the advertisement information, so that the latest advertisement information can always be dispensed to customers.

Further, the date and time of the obtaining of the object image data and/or the customer's personal data relevant to the object image data can be stored in a predetermined address of the image data as added information. It is thus possible for the customer, even when a great amount image data is being stored, to recognize where, when, and with whom each picture image has been taken, by referring to the added information. Hence, the added information can be used effectively in organizing the image data.

### [8-2] Second Example of the First Mode of Image Data Manipulation

FIG. 22 depicts a second example of an image data dispensing system according to any one of the above embodiments, to which system the first mode of image data manipulation technique is applied. In the following description, the second example of the image data manipulation technique of the first mode is applied to an image data dispensing system of the second embodiment, and the first example can be applied also to image data dispensing systems of the above first embodiment and the third through the seventh embodiments. In FIG. 22, like reference numbers to those which have already been described designate similar parts or elements, so their detailed description is omitted here.

An image data dispensing system of FIG. 22 is similar to that of the second embodiment depicted in FIG. 3 except that image manipulator 22 is replaced by image manipulator 22A and added information server 150 is additionally equipped to. In the above first example, added information, which is to be stored in image data by image manipulator 22A, is saved in added information storing unit 24, whereas, in the second example, the added information is saved in added information server 150 and sent therefrom to image manipulator 22A.

Added information server 150 includes added information storing unit 151, added information output unit 152, and added information updating unit 153. Added information storing unit 151 stores/reserves, in advance, added information (here, company advertisement: called “company data”) which is to be stored in image data by image manipulator 22A. In response to a request from image recording apparatus 20, added information output unit 152 reads out the added information, which is stored in added information storing unit 151, to send/output to image manipulator 22A. Added information updating unit 153 is connected with communication network 50, such as the Internet, to receive the latest company data from a company for updating the added information that is stored in added information storing unit 151.

As predetermined data manipulation, image manipulator 22A of image recording apparatus 20 of FIG. 22 stores the company data, which is received from added information server 150, in a predetermined address of the object image data.

Image writer 23 writes the resulting image data, to which the company data has been added by the image manipulator 22A, in image database 41 of image server 40. When storing the latest image data in an existing customer-dedicated storage area of image database 41, image writer 23 checks the company data stored in that customer-dedicated storage area. And then, if the data is not the latest one, image writer 23 reads out the latest company data from added information server 150 and updates the company data in the object image data.

In the image data dispensing system of FIG. 22, image recording apparatus 20 is directly connected with alternatively, both image server 40 and added information server 150, whereas image recording apparatus 20 can be connected with communication network 50, via which image recording apparatus 20, image server 40, and added information server 150 are connected in a communicable manner.

In the image data dispensing system of FIG. 22, customer terminal 60, which is connected with the system via communication network 50, carries out similar functions to those of dedicated viewer 140 by executing predetermined software (program), and hereby image data and its added information (company data) are shown by image display 61, separately in tiled windows or overlaid windows. At that time, since some of the customers might feel such company data annoying, customer terminal 60, which serves as dedicated viewer 140, is preferred also to have a function of switching ON/OFF the display of the company data.

With the above image data dispensing system, it is not only possible to attain the similar effects or profits to those of the image data dispensing system of FIG. 21, but also possible for a customer to see image data and its added information at the same time, so that various information can be obtained.

At the storing of the latest image data in an existing customer-dedicated storage area of image database 41, if the company data added to the image data that has previously been stored therein is found not to be the latest one, it is updated into the latest one that is read out from added information server 150. Hereby, it is always possible for a service provider to dispense the latest advertisement to customers.

Further, like in the system of FIG. 20, image manipulator 22A of image recording apparatus 20 can store the date and time of the obtaining of the object image data and/or the customer's personal data relevant to the object image data, in a predetermined address of the image data, as customer information. It is thus possible for the customer, even when a great amount image data is being stored, to recognize where, when, and with whom each picture image has been taken, by referring to the customer information on customer terminal 60. Hence, the customer information can be used effectively in organizing the image data.

If an image data dispensing system of FIG. 22 is applied to that of FIG. 17, or if the system is utilized in picture-taking in an athletic race, added information server 150 stores the race data, such as the title of the race, the date, and finish results (ranks and time records), as the added information. Such race data is written in image data by image manipulator 121 of image service provider 120.

### [8-3] Third Example of the First Mode of Image Data Manipulation

FIG. 23 depicts a third example of an image data dispensing system according any one of the above embodiments, to which system the first mode of image data manipulation technique is applied. In the following description, the third example of the image data manipulation technique of the first mode is applied to an image data dispensing system of the first embodiment. Since the third example is to be applied to an image data dispensing system in which each digital camera 10 is fixedly installed in a predetermined position, the third example is applicable also to image data dispensing systems of the above fourth through seventh embodiments. In FIG. 23, like reference numbers to those which have already been described designate similar parts or elements, so their detailed description is omitted here.

In the image data dispensing system of FIG. 23, digital camera 10 includes ID storing unit 16 as well as above-described CCD 11 and image data storing unit 12. Image recording apparatus 20 includes positional information database 25 as well as above-described image reader 21, image manipulator 22A, and image writer 23.

ID storing unit 16 stores identification (ID) information that is unique to each digital camera 10, and the ID information is to be added to every piece of image data that is obtained by digital camera 10. The ID information-added image data is transmitted from digital camera 10 to image recording apparatus 20 via image data storage medium 70.

Positional information database (positional information storing mean) 25 stores positional information of where each digital camera 10 is previously installed; the ID information of a digital camera 10 is stored in association with the positional data of the digital camera 10. Upon receipt of the ID information and the image data by image reader 21, the positional information is retrieved in positional information database 25 by the ID information. Image manipulator 22A then writes the retrieved positional information in a predetermined address of the image data as added information.

For example, assuming that one or more digital cameras 10 are installed in a park, by referring to an ID added to object image data, it is possible for the service provider to recognize which one of the digital cameras 10 took the object image, thereby acknowledging the position where the image data has been obtained. At that time, if the ID is associated with its positional data in advance, it is possible to store more specific positional information in the image data as added information. For example, if the object image data is obtained by digital camera 10 that is installed in front of a fountain, specific positional information, “XXX Amusement Park, in front of the central fountain” not simply “XXX Amusement Park”, is stored in the image data as added information.

In this manner, in case of where the image data is obtained by one or more digital cameras 10 that are fixedly installed, the positional information of each digital camera 10 can be stored in a predetermined address of the image data automatically, thereby eliminating efforts in checking and inputting such positional data separately.

### [9] Second Mode of Image Data Manipulation

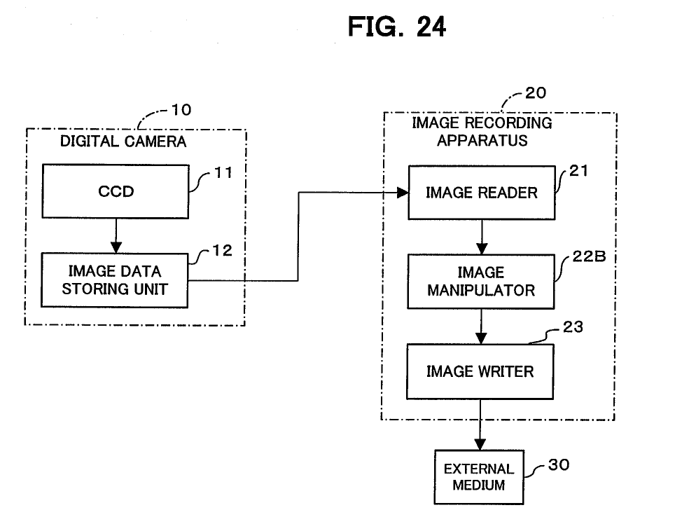

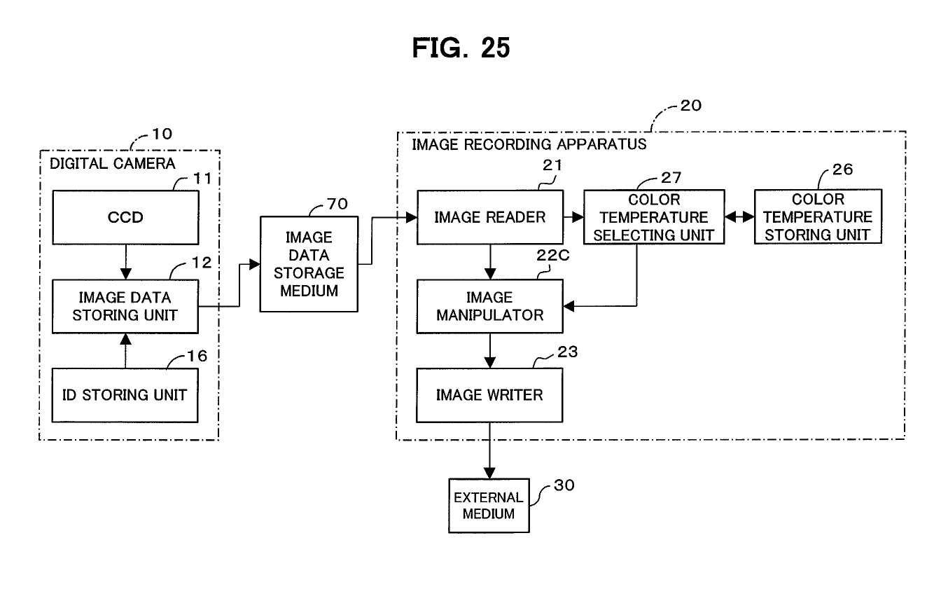

Next, a description will now be made hereinbelow of a second mode of image data manipulation technique according to the above embodiments of the present invention, with reference to FIG. 24 and FIG. 25. In the second mode, above-described image manipulators 22, 45, and 121 perform predetermined image-processing (item 22B of FIG. 24) or white balance correction (item 22C of FIG. 25) upon object image data.

A service provider performs some image-processing or white balance correction upon object image data when it is stored in external medium (portable medium) 30 or image servers 40, 123. Hereby, it is possible for customers to obtain the image data upon which predetermined data manipulation has been performed, without purchasing any dedicated device or software.

### [9-1] First Example of the Second Mode of Image Data Manipulation

FIG. 24 depicts a first example of an image data dispensing system according to any one of the above embodiments, to which system the second mode of image data manipulation technique is applied. In the following description, a first example of the image data manipulation technique of the second mode is applied to an image data dispensing system of the first embodiment, and the first example is applicable also to image data dispensing systems of the above second through seventh embodiments. In FIG. 24, like reference numbers to those which have already been described designate similar parts or elements, so their detailed description is omitted here.

Image recording apparatus 20 of FIG. 24 includes not only image reader 21 and image writer 23 but also image manipulator 22B. Image manipulator 22B performs some image-processing upon the object image data, as predetermined data manipulation. The image-processing performed by image manipulator 22B is, for example, the sharpening of the image for compensating a blurred focus, and color management for accurately reproducing colors in displayed images or printed images.

In the image data dispensing system of FIG. 24, since image manipulator 22B performs some image-processing (sharpening, color managing, and so on) upon object image data before its being stored in external medium 30 or image server 40 or 123 by image writer 23, it is possible for customers to obtain high-quality image data upon which predetermined image-processing has already been performed, even with no dedicated software nor operation skills.

### [9-2] Second Example of the Second Mode of Image Data Manipulation

FIG. 25 depicts a second example of an image data dispensing system according to any one of the above embodiments, to which system the second mode of image data manipulation technique is applied. In the following description, the second example of the image data manipulation technique of the second mode is applied to an image data dispensing system of the third embodiment. Since the second example is to be applied to an image data dispensing system in which each digital camera 10 is fixedly installed in a predetermined position, the second example is applicable also to image data dispensing systems of the above fourth through seventh embodiments. In FIG. 25, like reference numbers to those which have already been described designate similar parts or elements, so their detailed description is omitted here.

Image recording apparatus 20 of FIG. 24 includes image manipulator 22C, color temperature storing unit 26, and color temperature selecting unit 27 as well as above-described image reader 21 and image writer 23. Image manipulator 22C corrects the white balance of the object image data, as predetermined data manipulation.

Here, color temperature storing unit (color temperature information storing means) 26 stores color temperature information (available light color temperatures in the park) at each predetermined position where digital camera 10 is installed, by date and time, weather, and season. In color temperature storing unit 26, the ID information of a digital camera 10, which ID is unique to each digital camera 10, and the color temperature information with respect to the position where the digital camera 10 is installed are associated with one another.

Color temperature selecting unit (color temperature information determining means) 27 determines an available light color temperature for the object image data, in view of where the digital camera 10 that has obtained the image data is installed and when the image data is obtained, based on the color temperature information stored in color temperature storing unit 26. Upon receipt of an ID and object image data by image reader 21, the ID is transferred to color temperature selecting unit 27 as the positional information of the digital camera 10. Color temperature selecting unit 27 also receives the data of the date and time at which the image data was obtained. Color temperature selecting unit 27 selects/determines the most appropriate piece of color temperature information according to when and where the image was taken by digital camera 10, and sends the information to image manipulator 22C.

Image manipulator (white balance correcting means) 22C corrects the white balance of the object image data in accordance with the available light color temperature, which is determined by color temperature selecting unit 27.

In the image data dispensing system of FIG. 25, since the image data whose white balance has been correct by image manipulator 22C is stored in external medium 30 or image server 40 or 123, it is possible for customers to obtain high-quality image data upon which white balance correction has already been performed, even with no dedicated software nor operation skills.

Degraded image quality due to non-adjusted white balance has ever been a disadvantage of digital camera 10. The color temperature differs among: the rays of the sun on a fine day; the rays of the sun on a cloudy day; a fluorescent light; an incandescent light; and a flash light, and also depends upon the times of the day (daytime, evening, and others). Although existing digital cameras are equipped with the function of automatically adjusting the white balance according to a circumstantial light, it is still rather difficult to completely set the available light color temperature in an automatic way.

In the meantime, in the present system, the color temperatures are measured by time at every location of digital cameras 10. On the basis of the date and time and the place (where digital camera 10 is installed) of the obtaining of the image data, an available light color temperature is determined, and based on this color temperature, the white balance of the image data is corrected, thereby obtaining the high-quality image data. In particular, since, in a system in which digital camera 10 is fixedly installed, it is clear where the object image data was taken, the white balance can be corrected with high accuracy by measuring the available light color temperatures at each position where digital camera 10 is installed.

### [10] Others

The present invention should by no means be limited to the above-illustrated embodiments, and various changes or modifications may be suggested without departing from the gist of the invention.

For example, in the above embodiments, image obtaining apparatus are digital cameras such as digital still cameras and digital movie cameras, any equipment that can produce digital images or which converts analog images into digital ones, is also applicable.

Further, in the above examples, an image data dispensing system of the present invention is employed in an amusement park and in an athletic race, any facility or tourist attraction with a lot of opportunities to take pictures of customers is also applicable.

What is claimed is:

1. An image data dispensing system comprising:
an image obtaining apparatus, adapted to be lent to a customer, for obtaining image data by operation of the customer;
image manipulating means for manipulating said image data, which has been obtained by said image obtaining apparatus, by a predetermined manipulation process; and
image data dispensing means for dispensing the resulting image data, which is the image data as the result of said predetermined manipulation process by said image manipulation means, to the customer for a consideration.

2. An image data dispensing system comprising:
an image obtaining apparatus for obtaining image data;
an image data storing apparatus, adapted to be lent to a customer, for temporarily storing said image data obtained by said image obtaining apparatus;
image manipulating means for manipulating said image data, which is stored in said image data storing means, by a predetermined manipulation process; and
image data dispensing means for dispensing the resulting image data, which is the image data as the result of said predetermined manipulation process by said image manipulating means, to the customer for a consideration.

3. An image data dispensing system according to claim 2, wherein said image obtaining apparatus is previously installed at a predetermined position.

4. An image data dispensing system comprising:
a transmitter, adapted to be lent to a customer, for transmitting a signal including identification (ID) information of the customer;
an image obtaining apparatus, previously installed in predetermined position and having a receiver for receiving said signal from said transmitter, for obtaining image data in response to the receipt of said signal from said transmitter by said receiver;
an image data storing apparatus for temporarily storing said image data obtained by said image obtaining apparatus;
a communication network, communicably interconnecting said image obtaining apparatus and said image data storing apparatus, for communicating said image data and said ID information from said image obtaining apparatus to said image data storing apparatus;
image manipulating means for manipulating said image data, which is stored in said image data storing means, by a predetermined manipulation process; and
image data dispensing means for dispensing the resulting image data, which is the image data as the result of said predetermined manipulation process by said image manipulating means, to the customer corresponding to said ID information, for a consideration.

5. An image data dispensing system comprising:
an image obtaining apparatus for obtaining image data that includes ID information of a customer in the form of an image;
image manipulating means for manipulating said image data obtained by said image obtaining apparatus;
ID information extracting means for extracting said ID information from said image data obtained by said image obtaining means;
a database for holding personal information of the individual customer in correspondence with said ID information;
customer specifying means for obtaining said personal information of the customer by retrieving said database using said ID information, which has been extracted by said ID information extracting means, as a key, and for specifying the customer based on said obtained personal information;
notifying means for notifying an accessing technique to the customer who has been specified by said customer specifying means; and
image data dispensing means for dispensing the resulting image data, which is the image data as the result of said predetermined manipulation process by said image manipulating means, to the customer, who has been notified of said accessing technique by said notifying means, for a consideration.

6. An image data dispensing system according to claim 1, wherein:
said image data dispensing means includes image writing means for writing the resulting image data, which is the image data as the result of said predetermined manipulation process by said image manipulating means, into a portable medium, and
said portable medium, into which the resulting image data is written by said image writing means, is purchased by the customer, so that the resulting image data written therein is dispensed to the customer.

7. An image data dispensing system according to claim 2, wherein:
said image data dispensing means includes image writing means for writing the resulting image data, which is the image data as the result of said predetermined manipulation process by said image manipulating means, into a portable medium, and
said portable medium, into which the resulting image data is written by said image writing means, is purchased by the customer, so that the resulting image data written therein is dispensed to the customer.

8. An image data dispensing system according to claim 4, wherein:
said image data dispensing means includes image writing means for writing the resulting image data, which is the image data as the result of said predetermined manipulation process by said image manipulating means, into a portable medium, and
said portable medium, into which the resulting image data is written by said image writing means, is purchased by the customer, so that the resulting image data written therein is dispensed to the customer.

9. An image data dispensing system according to claim 5, wherein:
said image data dispensing means includes image writing means for writing the resulting image data, which is the image data as the result of said predetermined manipulation process by said image manipulating means, into a portable medium, and
said portable medium, into which the resulting image data is written by said image writing means, is purchased by the customer, so that the resulting image data written therein is dispensed to the customer.

10. An image data dispensing system according to claim 1, wherein:
said image data dispensing means includes:
an image server for storing the resulting image data, which is the image data as the result of said predetermined manipulation process by said image manipulating means; and
a communication network communicably interconnecting said image server and a customer terminal, and
the resulting image data stored in said image server is dispensed to said customer terminal via said communication network.

11. An image data dispensing system according to claim 2, wherein:
said image data dispensing means includes:
an image server for storing the resulting image data, which is the image data as the result of said predetermined manipulation process by said image manipulating means; and
a communication network communicably interconnecting said image server and a customer terminal, and
the resulting image data stored in said image server is dispensed to said customer terminal via said communication network.

12. An image data dispensing system according to claim 4, wherein:
said image data dispensing means includes:
an image server for storing the resulting image data, which is the image data as the result of said predetermined manipulation process by said image manipulating means; and
a communication network communicably interconnecting said image server and a customer terminal, and
the resulting image data stored in said image server is dispensed to said customer terminal via said communication network.

13. An image data dispensing system according to claim 5, wherein:
said image data dispensing means includes:
an image server for storing the resulting image data, which is the image data as the result of said predetermined manipulation process by said image manipulating means; and
a communication network communicably interconnecting said image server and a customer terminal, and
the resulting image data stored in said image server is dispensed to said customer terminal via said communication network.

14. An image data dispensing system according to claim 10, wherein said image data dispensing means further includes access managing means for managing access attempts of the customer from said customer terminal to the resulting image data stored in said image server, such that the accessing is permitted for a limited period depending upon an amount of charge said customer has paid for the consideration.

15. An image data dispensing system according to claim 11, wherein said image data dispensing means further includes access managing means for managing access attempts of the customer from said customer terminal to the resulting image data stored in said image server, such that the accessing is permitted for a limited period depending upon an amount of charge said customer has paid for the consideration.

16. An image data dispensing system according to claim 12, wherein said image data dispensing means further includes access managing means for managing access attempts of the customer from said customer terminal to the resulting image data stored in said image server, such that the accessing is permitted for a limited period depending upon an amount of charge said customer has paid for the consideration.

17. An image data dispensing system according to claim 13, wherein said image data dispensing means further includes access managing means for managing access attempts of the customer from said customer terminal to the resulting image data stored in said image server, such that the accessing is permitted for a limited period depending upon an amount of charge said customer has paid for the consideration.

18. An image data dispensing system according to claim 10, wherein said image data dispensing means further includes access managing means for managing access attempts of the customer from said customer terminal to the resulting image data stored in said image server, such that the accessing is permitted under condition that a predetermined amount of charge has been paid for the consideration.

19. An image data dispensing system according to claim 11, wherein said image data dispensing means further includes access managing means for managing access attempts of the customer from said customer terminal to the resulting image data stored in said image server, such that the accessing is permitted under condition that a predetermined amount of charge has been paid for the consideration.

20. An image data dispensing system according to claim 12, wherein said image data dispensing means further includes access managing means for managing access attempts of the customer from said customer terminal to the resulting image data stored in said image server, such that the accessing is permitted under condition that a predetermined amount of charge has been paid for the consideration.

21. An image data dispensing system according to claim 13, wherein said image data dispensing means further includes access managing means for managing access attempts of the customer from said customer terminal to the resulting image data stored in said image server, such that the accessing is permitted under condition that a predetermined amount of charge has been paid for the consideration.

22. An image data dispensing system according to claim 18, wherein said image data dispensing means further includes reference image producing means for producing a reference image from the resulting image data stored in said image server, said reference image being offered to the customer without consideration.

23. An image data dispensing system according to claim 19, wherein said image data dispensing means further includes reference image producing means for producing a reference image from the resulting image data stored in said image server, said reference image being offered to the customer without consideration.

24. An image data dispensing system according to claim 20, wherein said image data dispensing means further includes reference image producing means for producing a reference image from the resulting image data stored in said image server, said reference image being offered to the customer without consideration.

25. An image data dispensing system according to claim 21, wherein said image data dispensing means further includes reference image producing means for producing a reference image from the resulting image data stored in said image server, said reference image being offered to the customer without consideration.

26. An image data dispensing system according to claim 10, further comprising:
consideration collection managing means for managing the collection of a consideration to be paid for the resulting image data; and
image deleting means for deleting the resulting image data stored in said image server upon recognition by said consideration collection managing means that the consideration for the image data has not yet been collected even after elapse of a predetermined time period.

27. An image data dispensing system according to claim 11, further comprising:
consideration collection managing means for managing the collection of a consideration to be paid for the resulting image data; and
image deleting means for deleting the resulting image data stored in said image server upon recognition by said consideration collection managing means that the consideration for the image data has not yet been collected even after elapse of a predetermined time period.

28. An image data dispensing system according to claim 12, further comprising:
consideration collection managing means for managing the collection of a consideration to be paid for the resulting image data; and
image deleting means for deleting the resulting image data stored in said image server upon recognition by said consideration collection managing means that the consideration for the image data has not yet been collected even after elapse of a predetermined time period.

29. An image data dispensing system according to claim 13, further comprising:
consideration collection managing means for managing the collection of a consideration to be paid for the resulting image data; and
image deleting means for deleting the resulting image data stored in said image server upon recognition by said consideration collection managing means that the consideration for the image data has not yet been collected even after elapse of a predetermined time period.

30. An image data dispensing system according to claim 1, wherein said image manipulating means stores added information in a predetermined address of said image data.

31. An image data dispensing system according to claim 2, wherein said image manipulating means stores added information in a predetermined address of said image data.

32. An image data dispensing system according to claim 4, wherein said image manipulating means stores added information in a predetermined address of said image data.

33. An image data dispensing system according to claim 5, wherein said image manipulating means stores added information in a predetermined address of said image data.

34. An image data dispensing system according to claim 30, further comprising an image viewer for reading out said added data, which is stored by said image manipulating means, and showing said added data on its screen.

35. An image data dispensing system according to claim 31, further comprising an image viewer for reading out said added data, which is stored by said image manipulating means, and showing said added data on its screen.

36. An image data dispensing system according to claim 32, further comprising an image viewer for reading out said added data, which is stored by said image manipulating means, and showing said added data on its screen.

37. An image data dispensing system according to claim 33, further comprising an image viewer for reading out said added data, which is stored by said image manipulating means, and showing said added data on its screen.

38. An image data dispensing system according to claim 34, wherein said added information is an advertisement relevant to where said image data has been obtained.

39. An image data dispensing system according to claim 35, wherein said added information is an advertisement relevant to where said image data has been obtained.

40. An image data dispensing system according to claim 36, wherein said added information is an advertisement relevant to where said image data has been obtained.

41. An image data dispensing system according to claim 37, wherein said added information is an advertisement relevant to where said image data has been obtained.

42. An image data dispensing system according to claim 38, wherein said image manipulating means stores said added information together with another piece of information that designates a display available period during which said image viewer is adapted to show said added information.

43. An image data dispensing system according to claim 39, wherein said image manipulating means stores said added information together with another piece of information that designates a display available period during which said image viewer is adapted to show said added information.

44. An image data dispensing system according to claim 40, wherein said image manipulating means stores said added information together with another piece of information that designates a display available period during which said image viewer is adapted to show said added information.

45. An image data dispensing system according to claim 41, wherein said image manipulating means stores said added information together with another piece of information that designates a display available period during which said image viewer is adapted to show said added information.

46. An image data dispensing system according to claim 38, wherein said image manipulating means, if any other image data has been previously stored where the object resulting image data is to be stored, updates added information stored in such previous image data.

47. An image data dispensing system according to claim 39, wherein said image manipulating means, if any other image data has been previously stored where the object resulting image data is to be stored, updates added information stored in such previous image data.

48. An image data dispensing system according to claim 40, wherein said image manipulating means, if any other image data has been previously stored where the object resulting image data is to be stored, updates added information stored in such previous image data.

49. An image data dispensing system according to claim 41, wherein said image manipulating means, if any other image data has been previously stored where the object resulting image data is to be stored, updates added information stored in such previous image data.

50. An image data dispensing system according to claim 30, wherein said added information is where said image data has been obtained.

51. An image data dispensing system according to claim 31, wherein said added information is where said image data has been obtained.

52. An image data dispensing system according to claim 32, wherein said added information is where said image data has been obtained.

53. An image data dispensing system according to claim 33, wherein said added information is where said image data has been obtained.

54. An image data dispensing system according to claim 30, wherein said added information is when, or the date and time, said image data was obtained.

55. An image data dispensing system according to claim 31, wherein said added information is when, or the date and time, said image data was obtained.

56. An image data dispensing system according to claim 32, wherein said added information is when, or the date and time, said image data was obtained.

57. An image data dispensing system according to claim 33, wherein said added information is when, or the date and time, said image data was obtained.

58. An image data dispensing system according to claim 30, wherein said added information is the customer's personal data relevant to said image data.

59. An image data dispensing system according to claim 31, wherein said added information is the customer's personal data relevant to said image data.

60. An image data dispensing system according to claim 32, wherein said added information is the customer's personal data relevant to said image data.

61. An image data dispensing system according to claim 33, wherein said added information is the customer's personal data relevant to said image data.

62. An image data dispensing system according to claim 3, further comprising positional information storing means for storing positional information of the predetermined position where said image obtaining apparatus is previously installed,
said image manipulating means reading out the positional information, which is stored in said positional information storing means, corresponding to said image obtaining apparatus by which said image data has been obtained, and storing the readout positional information in a predetermined address of said image data, as added information.

63. An image data dispensing system according to claim 4, further comprising positional information storing means for storing positional information of the predetermined position where said image obtaining apparatus is previously installed,
said image manipulating means reading out the positional information, which is stored in said positional information storing means, corresponding to said image obtaining apparatus by which said image data has been obtained, and storing the readout positional information in a predetermined address of said image data, as added information.

64. An image data dispensing system according to claim 1, wherein said image manipulating means performs image processing upon said image data.

65. An image data dispensing system according to claim 2, wherein said image manipulating means performs image processing upon said image data.

66. An image data dispensing system according to claim 4, wherein said image manipulating means performs image processing upon said image data.

67. An image data dispensing system according to claim 5, wherein said image manipulating means performs image processing upon said image data.

68. An image data dispensing system according to claim 3, wherein said image manipulating means includes:
color temperature information storing means for storing color temperature information at the predetermined position where said image obtaining apparatus is installed, by date and time, weather, and season;
available light color temperature determining means for determining color temperature of available light for said image data, in view of where said image obtaining apparatus is installed and when said image data is obtained, based on said color temperature information stored in said color temperature information storing means; and
white balance correcting means for correcting white balance of the image data depending on the available light color temperature, which is determined by said available light color temperature determining means.

69. An image data dispensing system according to claim 4, wherein said image manipulating means includes:
color temperature information storing means for storing color temperature information at the predetermined position where said image obtaining apparatus is installed, by date and time, weather, and season;
available light color temperature determining means for determining color temperature of available light for said image data, in view of where said image obtaining apparatus is installed and when said image data is obtained, based on said color temperature information stored in said color temperature information storing means; and
white balance correcting means for correcting white balance of the image data depending on the available light color temperature, which is determined by said available light color temperature determining means.
